(19) United States
(12) Patent Application Publication
(10) Pub. No.: US 2004/0163044 A1
(43) Pub. Date: Aug. 19, 2004

(54) Method and apparatus for information factoring

(75) Inventor: Russell Toshio Nakano, Sunnyvale, CA (US)

Correspondence Address: Russell T. Nakano, 1326 Alridge Dr., Sunnyvale, CA, 94087, US

(73) Assignee: Nahava Inc., Sunnyvale, CA (US)

(21) Appl. No.: 10/368,060

(22) Filed: Feb. 14, 2003

(51) Int. Cl. G06F 15/00

(52) U.S. Cl. 715/513

(57) ABSTRACT

A method and apparatus for information factoring have been disclosed by representing a source information asset as a point in a metric space and rendering said source information asset in a second form.

### FIELD OF THE INVENTION

The present invention pertains to information. More particularly, the present invention relates to a method and apparatus for factoring information.

### BACKGROUND OF THE INVENTION

There is an explosive expansion of information content in our modern world. Notable examples in the public arena include web sites, news streams and information feeds. In the non-public arena, examples include communication pathways such as corporate email, personal email, and discussion threads. All of these sources contain valuable information, however, the essential information often lies buried or intermixed with redundant data.

Information factoring transforms a collection of information assets into a more compact representation, while minimizing the information loss associated with the compact representation. A number of important problems that arise in the information technology sector may be viewed as information factoring problems. For example, the field of web content management frequently encounters the problem of content extraction, which may be summarized as follows. A typical collection of web assets is represented in HTML. As is known within the industry, HTML may mix content and presentation. For example, the HTML-based home page of a web property may contain a promotional text for a marketing campaign side-by-side with elements that communicate the company's color, style, and layout. Modern web content systems strive to separate content from the presentation because separating content from presentation allows the textual content to be changed independently of the look-and-feel. This explains why content management systems designed to replace HTML-based systems strive to achieve this kind of separation. Hence, the content extraction problem aims to separate content and presentation in the original collection of assets.

In general, applications of information factoring arise when there is a large body of unstructured or partially structured content that contains a discernable redundancy. The body of source content may be an unchanging set, such as a web site, or it could be an ongoing feed of content, such as an email stream or news feed.

The challenges posed by a large body of content with discernable redundancy are enormous. First, the redundancy bloats an already large source. Second, the redundancy complicates efforts to reuse, repurpose, transform, or interpret the content. Third, the volume of the content makes it expensive or time-consuming to engage the services of human operators to sift through the individual units to discern and extract the useful content apart from the redundant content. This presents a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be implemented;

FIG. 2 is a block diagram of a computer system which may be used for implementing some embodiments of the invention;

FIG. 3 pictorially illustrates one embodiment of the invention showing an information asset projected onto a plane of admissible elements,

FIG. 4 illustrates one embodiment of the invention showing a language neutral template extraction to various languages'

FIGS. 5, 6, 7, 8, 9, 10, 11, and 12 illustrate various content, and a sample extraction according to one embodiment of the invention;

FIG. 13 illustrates a more detailed view of an extracted template according to one embodiment of the invention;

FIG. 14 illustrates an analysis report for a sample extraction according to one embodiment of the invention;

FIGS. 15, 16, 17, 18, 19, and 20 illustrate more examples of content, and extraction according to one embodiment of the invention;

FIG. 21 illustrates output as a set of XML files according to one embodiment of the invention;

FIGS. 22, 23, 24, 25, 26, 27, 28, 29, and 30 illustrate one possible embodiment of the invention as a procedure, showing example XML, a tree structure, an information model, selecting subtrees, candidate cut points, residual, extracted content, and a goodness according to one embodiment of the invention;

FIGS. 31, 32, 33, 34, 35, 36, 37, 38, 39, and 40 show the invention as illustrated in FIGS. 22-30 might operate on a simple example; and

FIGS. 41, 42, 43, and 44 show in flowchart form various embodiments of the invention.

### DETAILED DESCRIPTION

A method and apparatus for information factoring are described.

Information factoring transforms a collection of information assets into a more compact representation, while minimizing the information loss associated with the compact representation.

Overview

For purposes of explanation, of the invention, assume that the source content can be subdivided into a collection of discrete logical units, {yi}. A logical unit, yi, may be a single web page, a single message posting, or equivalent, chosen because there are apparent redundancies among the units. Without loss of generality, assume that either a logical unit xi is represented as XML (extensible Markup Language), or there is a lossless transformation from its original form into XML and vice versa. XML serves as a convenient lossless target representation.

Using the above assumptions, to explain one embodiment of the invention, it is now possible to define information factoring as the problem of deriving a compact representation of a collection of N source XML documents, Y={yi}. The source XML documents contain a discernable amount of redundancy between them. An XML representation X={xi} of the source documents is compact if there can be derived a “template” or “stylesheet,” xp, which can combine with each xi to produce an approximation of the original yi. In other words,

yi˜(xp*xi),

where “˜” means “approximately equal,”

and “*” means to “render the content using the stylesheet.”

xp maps the XML expression xi, to an XML expression that approximates the original yi.

The notion of approximation, or more precisely the closeness of an approximation, follows an information theoretic viewpoint. Interpret each source document yi as a random variable from the space of XML documents. An XML document is a collection of tags organized into a tree data structure, with associated attributes and values. Assume that there is an underlying model that generates the source documents yi.

Information theory tells us that there is a distance metric between two random variables, x and y,

D(x,y)=H(x|y)+H(y|x),

where H(x|y)=conditional entropy of x, given y

=E(log(1/p(x|y)))

=sum(x,y over their respective sample spaces; p(x,y) log (1/p(x|y)).

It follows that

$$D ( x - y ) = E ( log ( 1 / p ( x \vert y ) ) + log ( 1 / p ( y \vert x ) ) ) \\ = sum ( x , y ; p ( x , y ) [ log ( 1 / p ( x \vert y ) + log ( 1 / p ( y \vert x ) ) ] .$$

This distance metric has an appealing interpretation. The distance is the expected number of bits of information that need to be conveyed to learn about y, if x is known. Since D(.) is symmetric, the same interpretation holds for x, if y is known.

A perfect representation of yi would allow a precise recreation yi=xp*xi. This occurs if such a template xp can be exactly derived. (Ignore the trivial solution of xp that essentially says, if i=1, then produce y1, else if i=2 then produce y2, etc.)

In general, seek an approximation,

yi˜xp*xi

such that each xi is a “k-extract.” That is, xi selects k disjoint subtrees of yi. Generally, k is a small integer. Since the stylesheet xp renders the selections as y-hat i=xp*xi, one approach is to minimize the information theoretic distance between Y={yi} and xp*X={xp*xi).

This may be viewed as information factoring because the solution yields a single common template or stylesheet, xp, that recreates the yi from a k-extract, xi. The rendering xp*xi is optimal in the sense that is a minimized information loss that separates the source content yi from the extracted content xi. Moreover, the apparent redundancy in the yi has been “factored” into a common stylesheet. The original content has been separated: the discernable redundancy has been factored out, while the essential content of the original has been selected and separated into individual units.

One skilled in the art will observe that this factoring can be repeated to yield successively better approximations to yi, as in,

yi˜xp1*x1i+xp2*x2i+xp3*x3i+ . . .

Model of Residuals

Given two random variables x and y, with a joint probability distribution p(x,y), there's a distance metric D(x,y), defined as

D(x,y)=H(x|y)+H(y|x)

Where H(x|y) is the conditional entropy of x, given y.

H(x|y)=sum(x,y over their respective sample spaces; p(x,y) log (1/p(x|y)).

It follows that

D(x, y)=sum(x, y; p(x,y)[log(1/p(x|y)+log(1/p(y|x))].

If x and y are independent, then p(x|y)=p(x), and p(y|x)=p(y). Therefore, in this special case

$$D ( x - y ) = sum ( x , y ; p ( x ) * p ( y ) log [ 1 / ( p ( x ) * p ( y ) ) ] \\ = sum ( x ; p ( x ) * log ( 1 / p ( x ) ) + sum ( y ; p ( y ) * log ( 1 / p ( y ) ) \\ = H ( x ) + H ( y )$$

In the other special case that x and y are related by a one-to-one mapping, say by a mathematical or textual transformation, then p(x|y)=p(y|x)=1. This yields D(x,y)=0.

The distance D(x,y) can be interpreted as the additional expected number of bits that need to be used to represent y, if x is known.

Thus, the templating problem may be stated as,

a. There are N pages of text, say XML.

b. Let yi be the ith original page, the observations.

c. Let xi be the extracted content from yi. xp is the presentation, say XSL (XML Style Sheet).

d. A goal is to choose xp to minimize the magnitude of the residuals,

D(y, xp*x)=(1/N)*sum(i-th page; log(1/(p(residuals remaining on i-th page))).

The problem reduces to determining the probability of obtaining the residuals on the i-th page. For example, solving the subtraction problem yi−xp*xi, to obtain the residuals for the i-th page.

For example, to illustrate use in one embodiment of the invention, use the following model for a page. A page consists of a tree of tags, such as <html>, <body>, <p>, etc. For now, assume that the tags are given. Each tag has a value, which is drawn from a distribution. Use the observed frequency of values associated with that particular tag. For example, the <b> tag might be associated with values “hello” and “world.” In 10 occurrences of <b>, it may be seen that “hello” appears 6 times and “world” appears 4 times. Thus, the probability of <b>hello</b> is 0.6. Further assume that each tag is independent. Therefore, to compute the probability of a given set of residuals corresponding to a page, take the tags and use the observed frequency of occurrence, and take the product. This yields,

D(y, xp*x)=(1/N)*sum(i-th page; sum(j-th tag on page i; 1/log(p(value of tag j|tag j))).

This model may be further improved by using the pairwise joint probability distribution of pairs of tags, knowing the other tags and values that appear on the same page.

One Technique

In one embodiment of the invention the technique detailed below may provide a solution for information factoring.

0. Given N pages {yi}. The goal is to find the optimal presentation xp, to minimize the distance between the projection xp*xi, from the original. In other words, minimize D(y,xp*x).

1. Decide how many items that the presentation will contain.

2. Traverse the pages yi, and the tags tij within each page. This details all the possible tags.

3. For each page yi, traverse over the tags and obtain the observed probabilities of the tag values. For each node in the tree for page yi, compute the residual as if that node and above were to be considered part of the template. Everything below would be part of the extraction, and hence wouldn't contribute to the residual.

4. Take the potential residuals computed in step 3 over all the pages, and compute the residual associated with a node and everything below it. That residual would be removed from the total for all the pages if that node (tag path) were chosen as the template. Note that only certain tags are valid cut points for the tag paths.

5. The cut points or tag paths define the template. Other parts outside the cut point need to use the minimal entropy choice of tags and values.

6. Determine the best cut point by looking at the rate of change of the total residual below each candidate cut point. Call this the lower residual; it is the total sum of residuals for all nodes that have the cut point as a direct or indirect parent node. Define the possible cut points by sorting by the “lower-residual.” The root node has a lower residual consisting of the total residuals for the entire page. As one goes deeper into the tree, the lower residual diminishes. One approach is to balance two goals. The first goal is to capture as much common content as the “template” or “presentation.” The second goal is to extract as much different content into the xi. The first goal wants to choose a cut point as deep as possible into the tree, while the second goal wants to choose a cut point closer to the root. The optimal cut point is the point (or points) that define the “knee” in the residual curve, plotted as a function of sorted potential cut points. Numerically, this may be determined where the rate of change of the residuals is the greatest.

7. An effective way to select the cut points is to look at the following ratio:

Goodness=pct/(1−pct),

Where pct=the percentage of the contribution that a given node makes to the total lower-residual of its parent. This ratio has an appealing interpretation. It is the ratio of the current node's contribution versus the contribution of its sibling nodes. The higher the ratio is, indicates that the node is more effective in contributing to its immediate vicinity.

8. Repeat sequence 3-6 to refine the approximation, as necessary. The difference between the original and the expansion, y−xp*x, gives a residual, which becomes the new source information. Proceed to fit another model to the residuals. Because the solutions are additive, one can reconstruct the original pages from the sum of the models found on each iteration of the solution technique.

Extraction Problem as Best-Fit

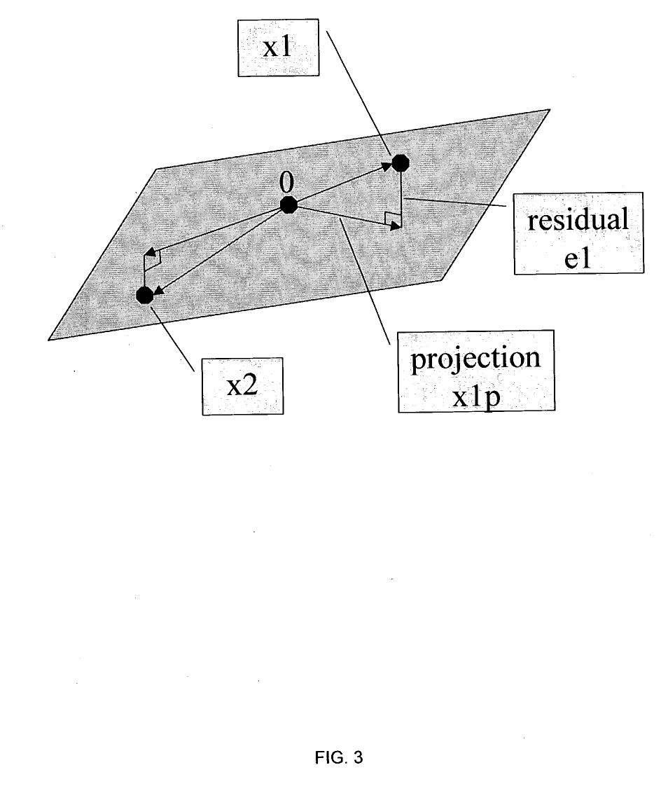

Pictorially, as shown in FIG. 3, a plane can represent the space of admissible elements xp, multiplied by the different xic as extracted content. Observe that because the distance metric is conditioned by the frequency of occurrence of elements of S, that the presentation xp is an eigenvector in the space S.

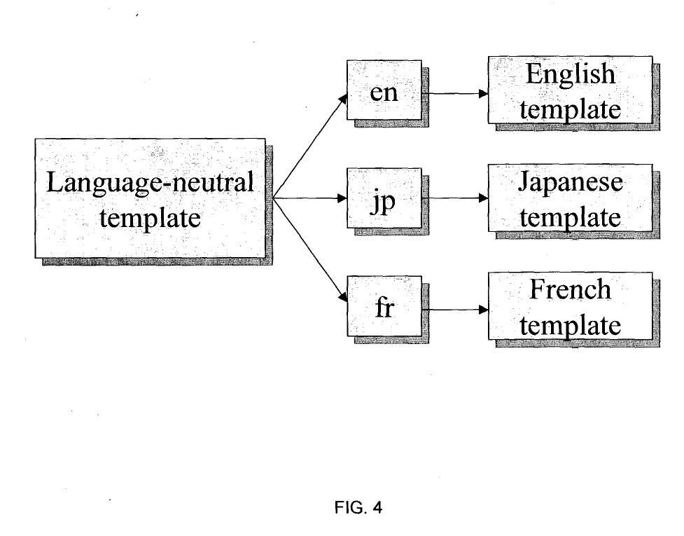

Also observe that this procedure may be repeated on any XML space S. This means that a collection of presentations xp can be viewed as a space that can be factored in an identical manner. For example, this occurs in websites that are rendered in different languages. For example, a presentation template for English is likely to be the similar, if not identical for German or French, just with a different use of language text. If the language templates are themselves factored, there will be a single language-neutral template as illustrated in FIG. 4.

In general, the model can be extended,

y˜xp1*xc1+xp2*xc2+ . . . *xpk*xck+e

Notice that in this formulation, the xp1, . . . , xpk form a basis, in some sense, of the data set y. Consider Y to be the vector of observations from the space X, and Xc1, . . . , Xck are the factored data, this can be written as,

Y˜xp1*Xc1+xp2*Xc2+ . . . *xpk*Xck

One can interpret the distance,

D(Y, xp1*Xc1+xp2*Xc2+ . . . *xpk*Xck)

as measuring the “error” or “residual” arising from the approximation problem. This framework sets up the problem, which involves solving for the xp's. One of skill in the art will appreciate that one may partition the input set into groups and compute the regression separately.

Thus, required aspects of solving the extraction problem as an optimization problem over the space of data models have been described.

Overall

Detailed below is an overview of an algorithm that may be used in one embodiment of the invention.

Given: A collection of N XML expressions.

Objective: Given a budget of m, where m<<N templates, construct m templates and N content XML expressions that best approximate the original collection of XML expressions. Discussion: The plan is to factor out m templates from the XML expressions, so that as much as possible of the remaining content is placed into XML content expressions that can be “rendered” via one of the templates. Rendering consists of recombining a template with the content that was “cut” from it during the cut-point algorithm. This results in the best approximation of the original XML expression in the following sense. Any content from the original XML expressions that appears neither in the templates, nor in the content expressions is deemed to be the residual error. One can carefully choose the templates and content to minimize the magnitude of the residual error. The residual error has an information-theoretic interpretation as the information distance between the original content and the rendered content. Therefore, this solution is “best” in the sense of minimizing the information distance between the original and the rendering.

1. To visualize how the algorithm works, think of an expression as a web page for two reasons. First, a web page is familiar to everyone. Second, when the algorithm “factors” the page into the template part and the content part, it is easy to visualize the corresponding separation on the web page. It should be clear that the algorithm itself only relies on the tree-structure of the HTML or XML tags and embedded content, and that this algorithm may be applied to any collection of tree structures with embedded content.

2. Order the web pages by their file path, so that files in the same directory follow in sequence. This is done to make it more likely that consecutive XML expressions have redundant elements, however if this step is impractical or impossible, then choosing a larger batch size, as explained below compensates for the absence of a favorable initial ordering.

3. Initialize a work queue with the web pages in the chosen initial order.

4. For each web page placed into the work queue, traverse over the node names of the XML and the content contained in the nodes in a pre-determined order, say depth-first. While traversing, compute a digest of the names and the content. For example an MD5 hash works well. The digest succinctly captures the tree structure and the content, so that two trees with the same node structure and content will produce the same digest value.

5. Process files in batches; say of size n<N. Pick each batch from the front of the work queue.

6. As described in detail previously, decide the number of cut points k, that will be computed for each batch. Typically k is small, 1-4. (This is because it is possible to apply the factoring procedure repeatedly over a given page's content, thus if a given cut point isn't chosen on one iteration because the value of k is small, it is very likely to be selected in a future iteration.)

7. For each batch, compute the k cut points. Recall that a cut point satisfies the two properties that the total residual, below that point is largest overall (information content), and that the contribution is relatively concentrated at that point (effectiveness).

8. As each page is partitioned into the nodes that are below the cut points (“the content”), and above the cut points (“the template”), set aside the content, but place the templates into the collection of web pages to factor. For example, it works well to put each template at the end of the work queue.

9. Before placing a template into the work queue, compute its digest as described above. Put the template into the work queue only if the digest hasn't been seen previously. This assures that when two pages have their content factored by removing data at the cut points, and the resulting templates are identical as far as content and tags, then only one of them will be subsequently processed.

10. Eventually the procedure terminates when all source web pages and all computed templates have been processed.

11. At this point, the contents of each original web page can be reconstituted. Specifically, when a page is factored, keep track of the content and the template for that page. When the template is factored, keep track of its content and the resulting (2^{nd}) generation template. Repeat this for the 3^{rd}, 4^{th} generation, etc. By this means, when the procedure concludes, one can retrace the steps of the factoring and identify all the content files that resulted from all the factoring operations for a given page. The collection of all such content files is the sum total of the content for that page.

12. Similarly, the template files that result from successive factorings of a given source page are successively more abstract representations of the internal structure of the original page.

13. The template files have a special structure that one may exploit. Each template file has a digest that was computed earlier, which describes the tag structure and content. One may consider all the templates that have the same digest to be equivalent. Therefore, without loss of generality, one can pick one template to represent all the other templates with the same digest. This can be done because the digests form equivalence classes of templates.

14. The goal is to choose a collection of templates that best describes the original set of web pages. To make the problem concrete, one wants to pick the m best templates, where m is typically a small number.

15. Since it is known that each template is the result of a factoring of content into the template part and the content part. It follows that for each representative template from its equivalence class, one can sum the total residual for the nodes “cut” from that template. (As an alternate metric, one can count the number of pages whose content is directly factored from that template.)

16. The best m templates consist of the templates that have the highest total residual (or highest number of pages).

17. One can now reconstruct the best templatized approximation to the original web site. All the content directly associated with the m-best templates goes into the extracted data, xci. The templates xpj provide the presentation for that content. All the remaining extracted content become the residual error, yi−xpj*xci. The error has been minimized, because the content was selected that would represent the highest amount of residual to go into the content xci. Within a “budget” of m templates, one is left with the unselected content as the “error” terms.

Thus, a method, and apparatus for information factoring, and optimal modeling of an XML information source have been described.

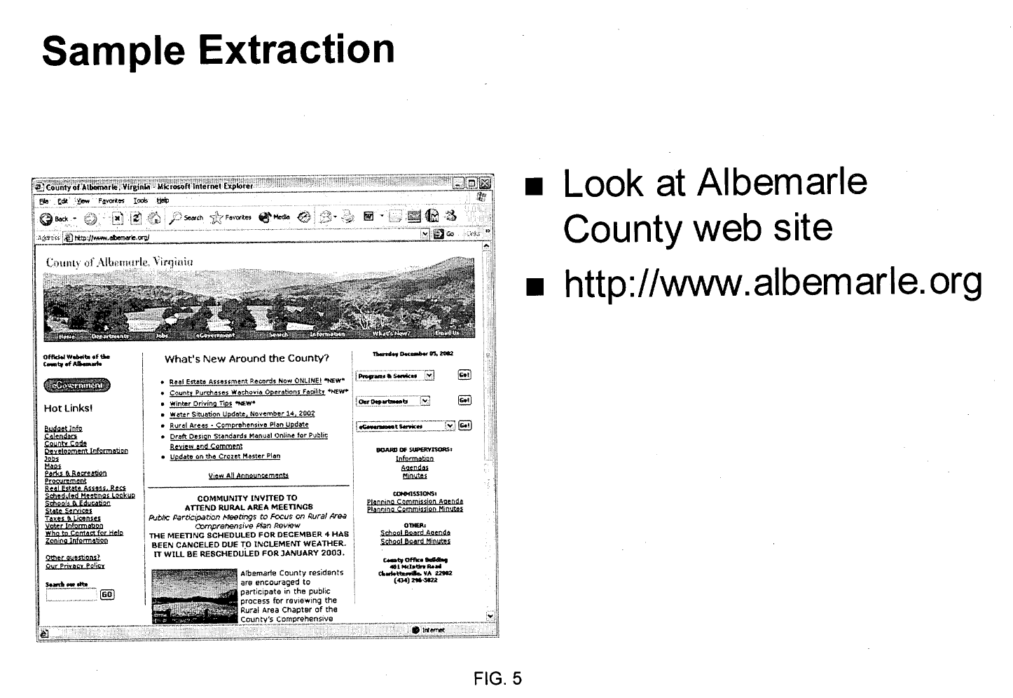

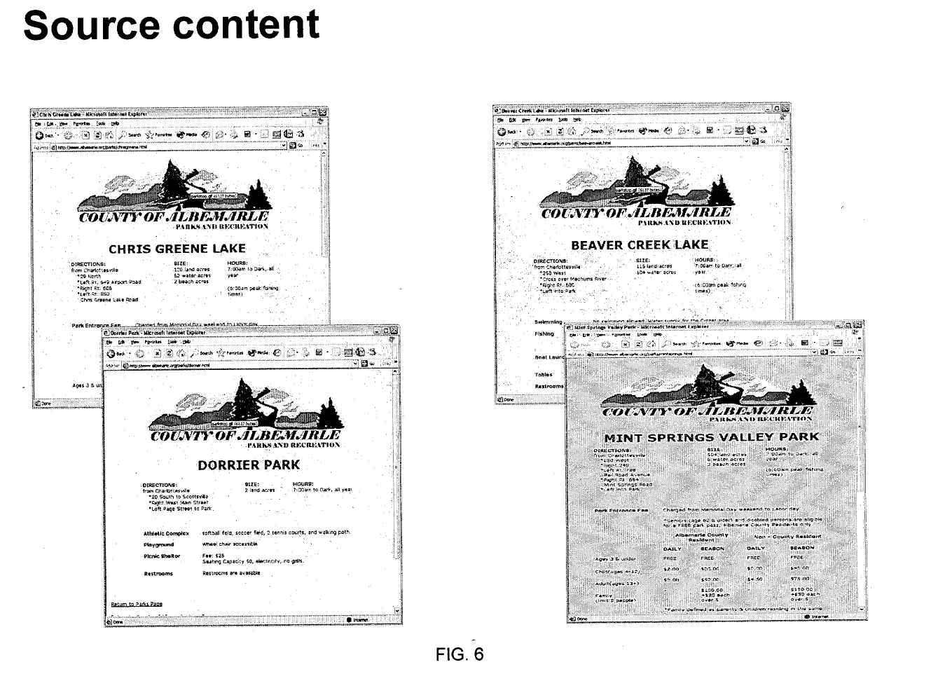

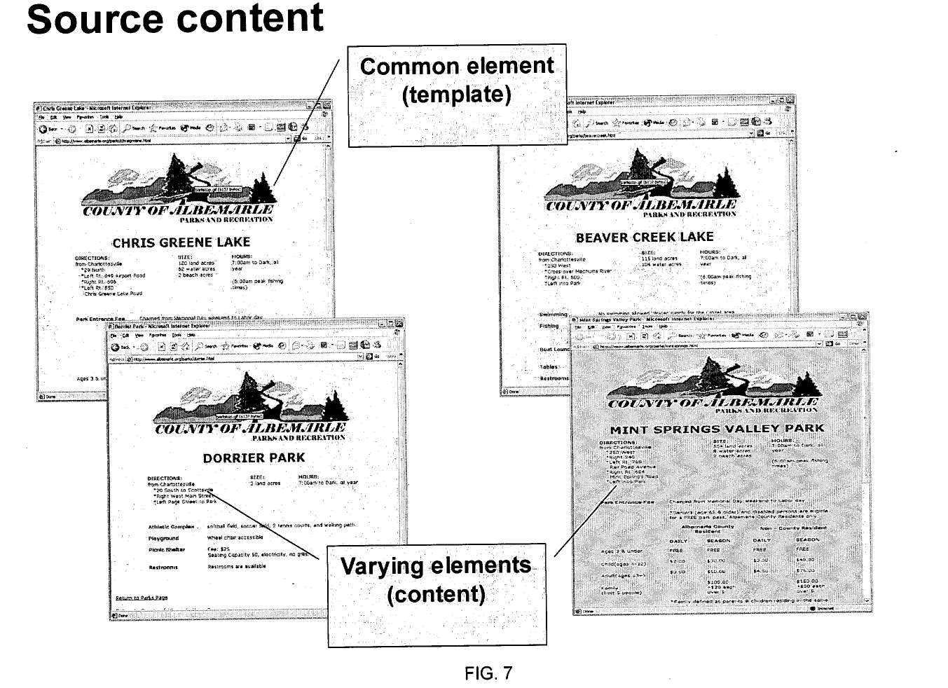

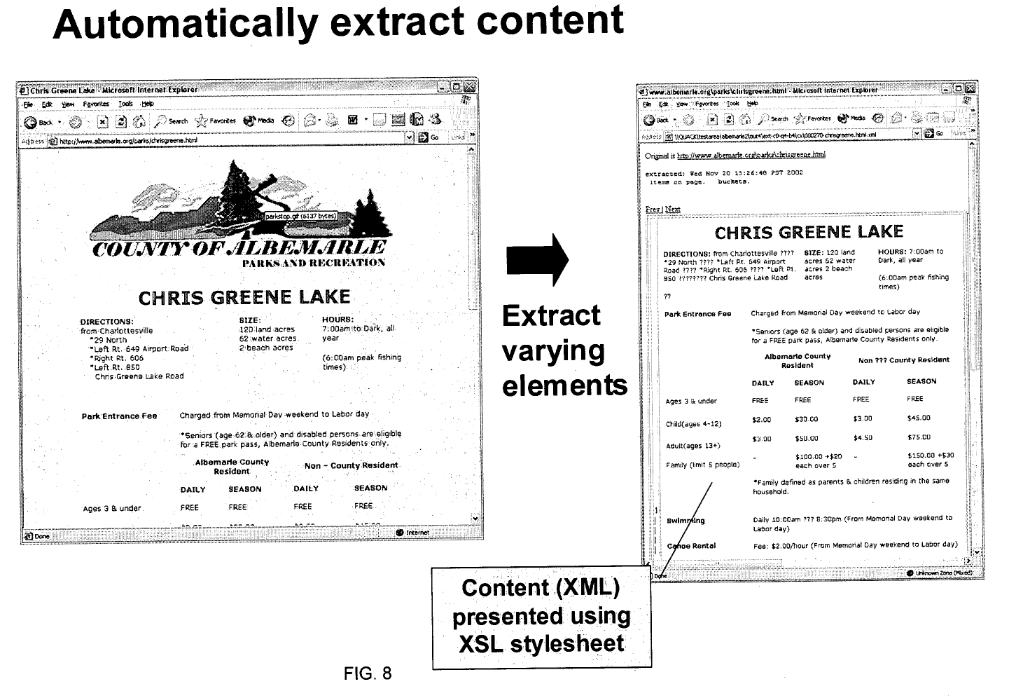

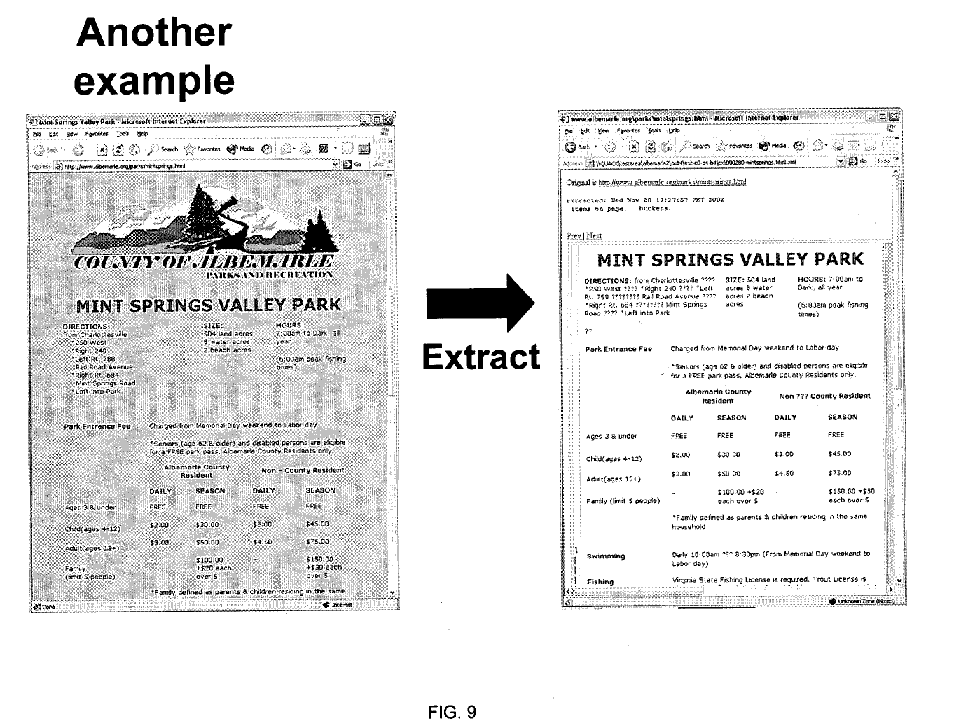

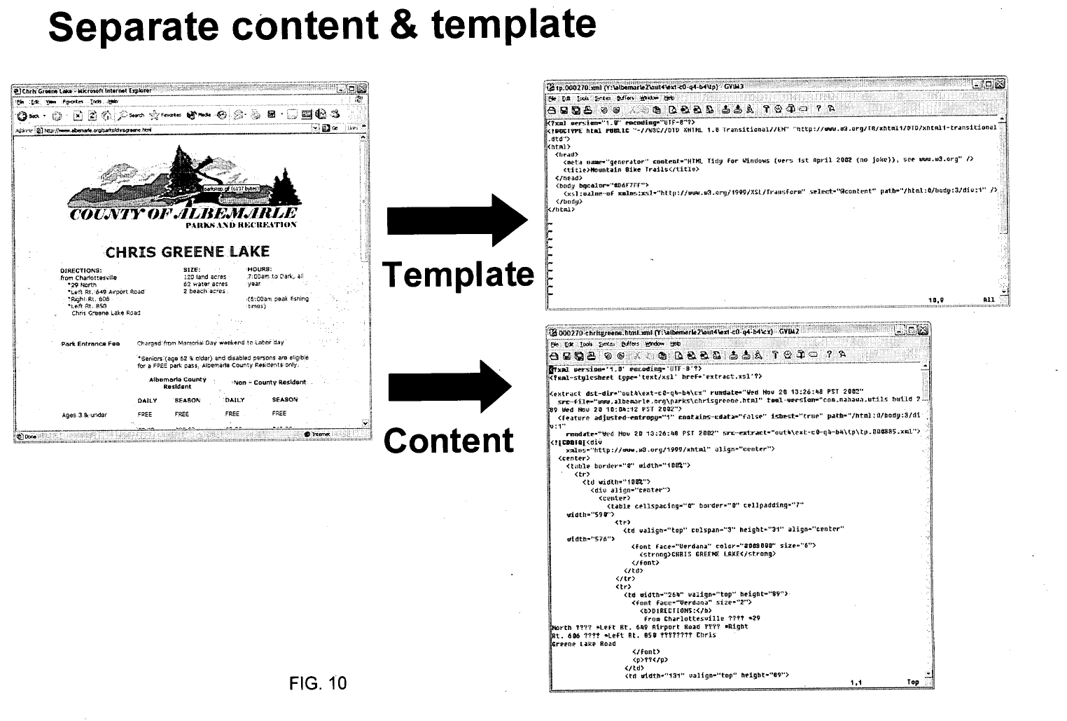

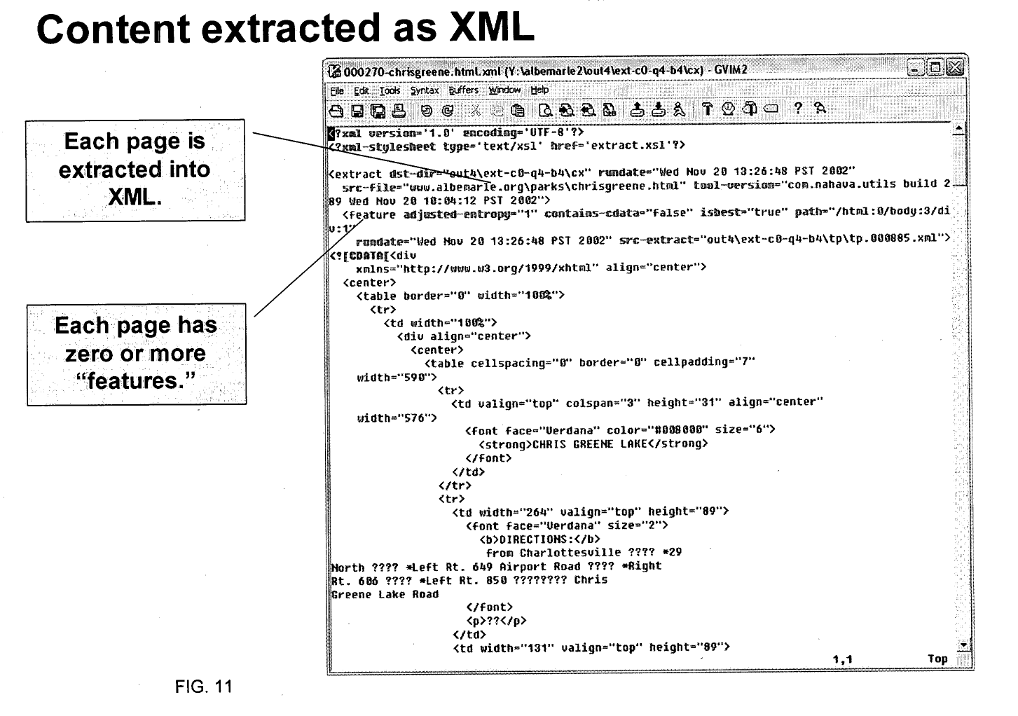

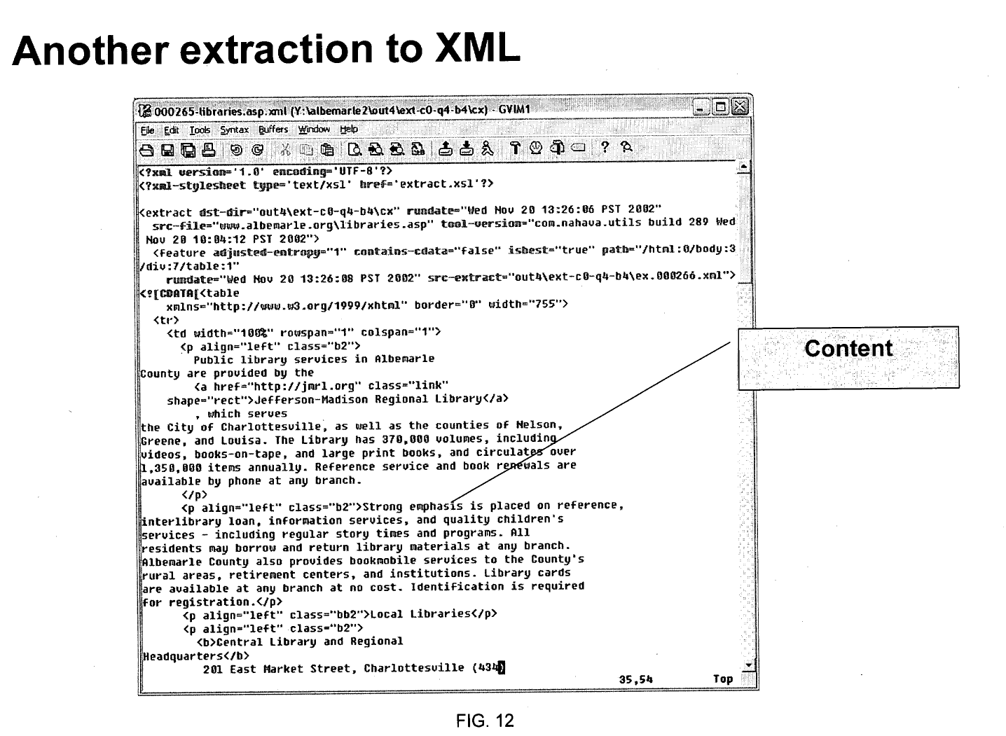

FIGS. 5, 6, 7, 8, 9, 10, 11, and 12 illustrate various content, and a sample extraction according to one embodiment of the invention. FIG. 5 show a county web site. FIG. 6 shows four source contents from this county web site for four different recreation areas. From upper left moving clockwise they are Chris Green Lake, Beaver Creek Lake, Mint Springs Valley Park, and Dorrier Park. FIG. 7 points out a common element on these sites, for example, the County of Albemarle text and graphic. This common element may be considered a template that was used during the creation of these pages. Varying elements, such as, the location, description, and directions to the facilities may be considered content. FIG. 8 illustrates extracting the varying elements for Chris Green Lake. The presentation on the rightmost pane is content (XML) presented using XSL stylesheet. FIG. 9 shows another example of extraction using Mint Springs Valley Park. FIG. 10 illustrates extracting a separate content and a separate template for Chris Greene Lake. FIG. 11 illustrates in greater detail content extracted as XML. As illustrated, each page is extracted into XML and each page has zero or more features. FIG. 12 shows another content extraction to XML.

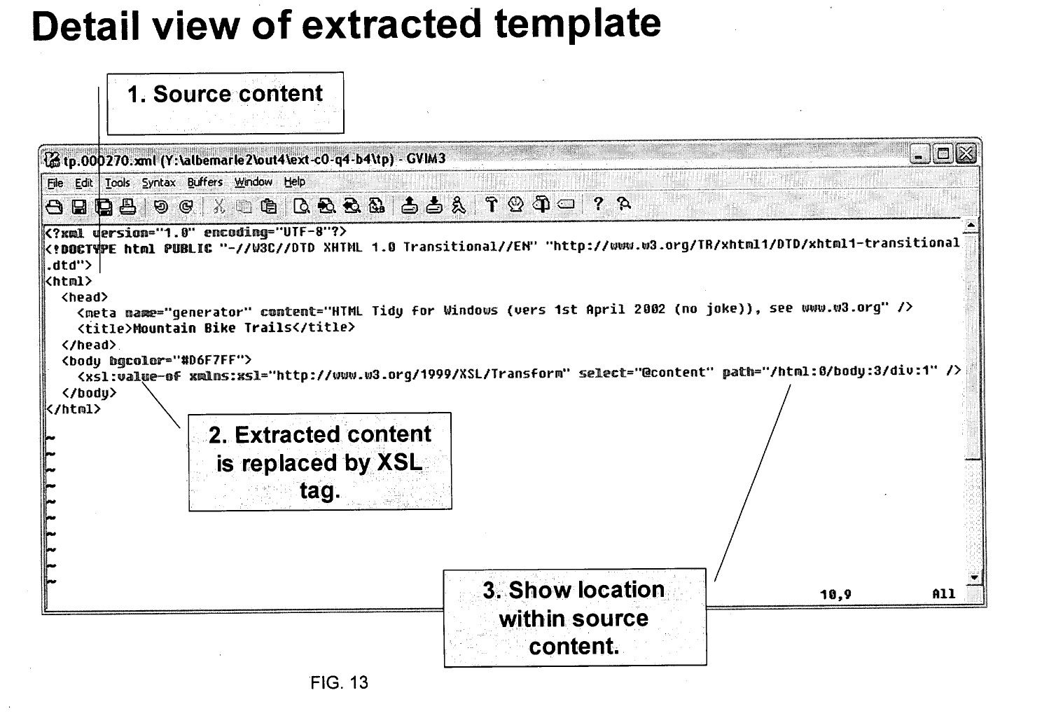

FIG. 13 illustrates a more detailed view of an extracted template according to one embodiment of the invention. This detailed view shows the source content (1), extracted content replaced by XSL tag (2), and shows the location within the source content (3).

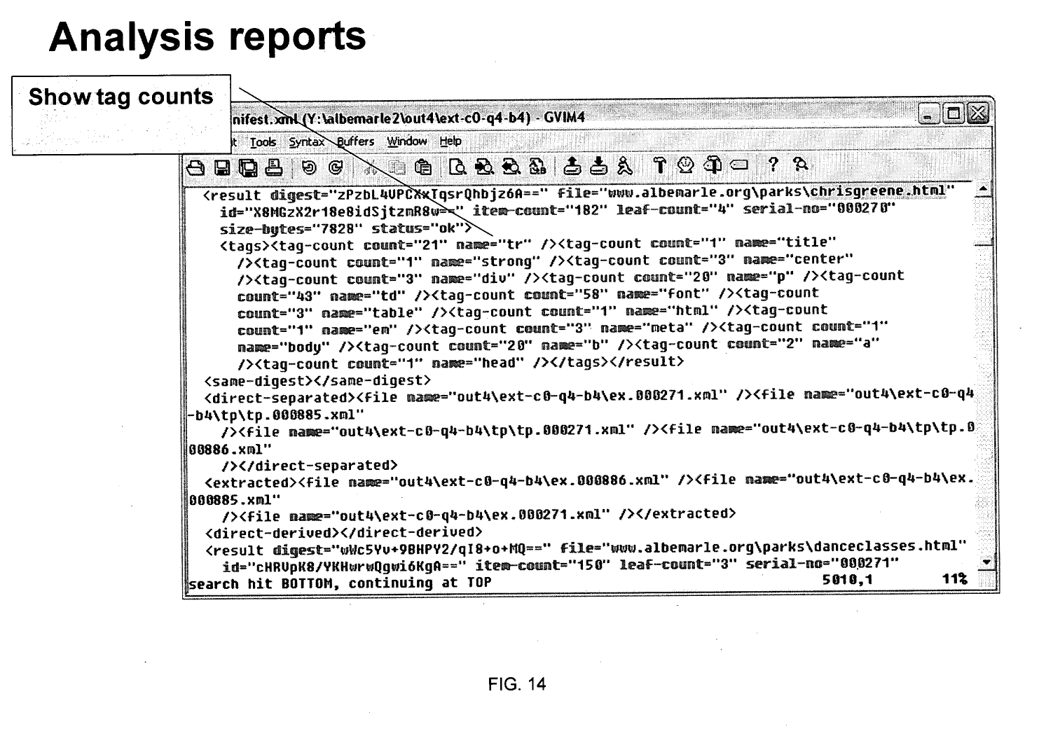

FIG. 14 illustrates an analysis report for a sample extraction according to one embodiment of the invention. Shown here is an illustration of tag counts.

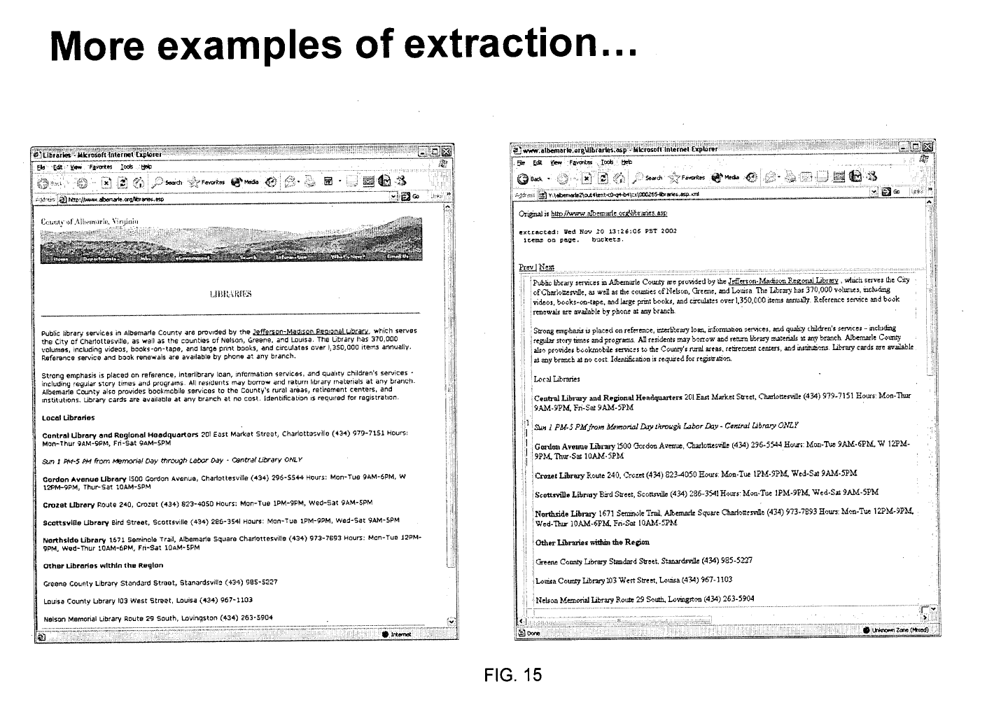

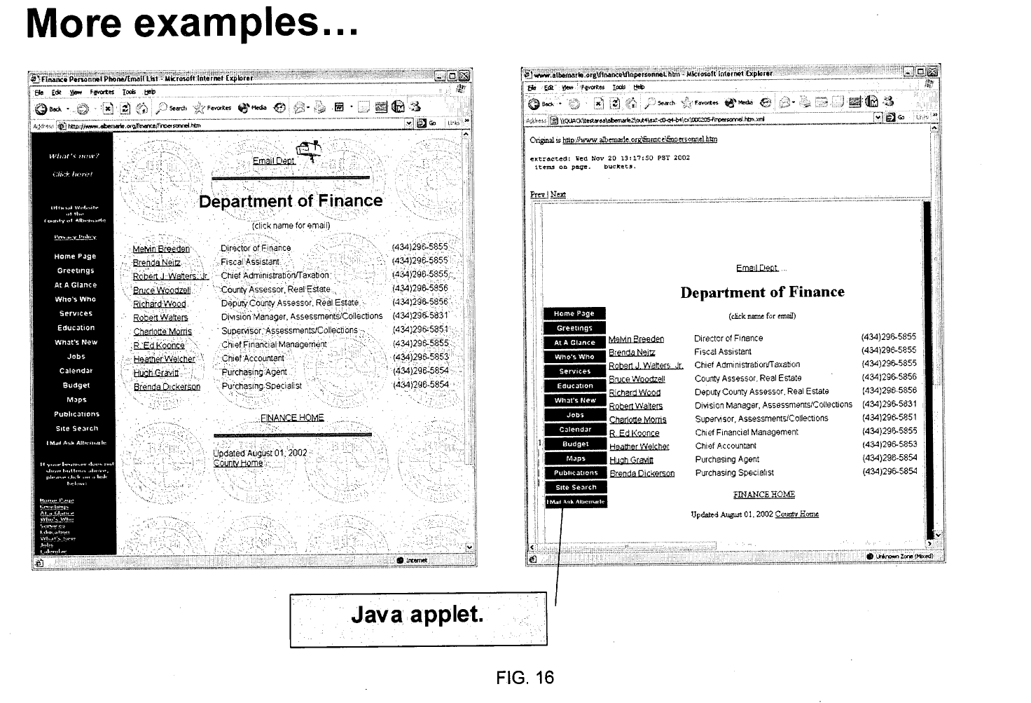

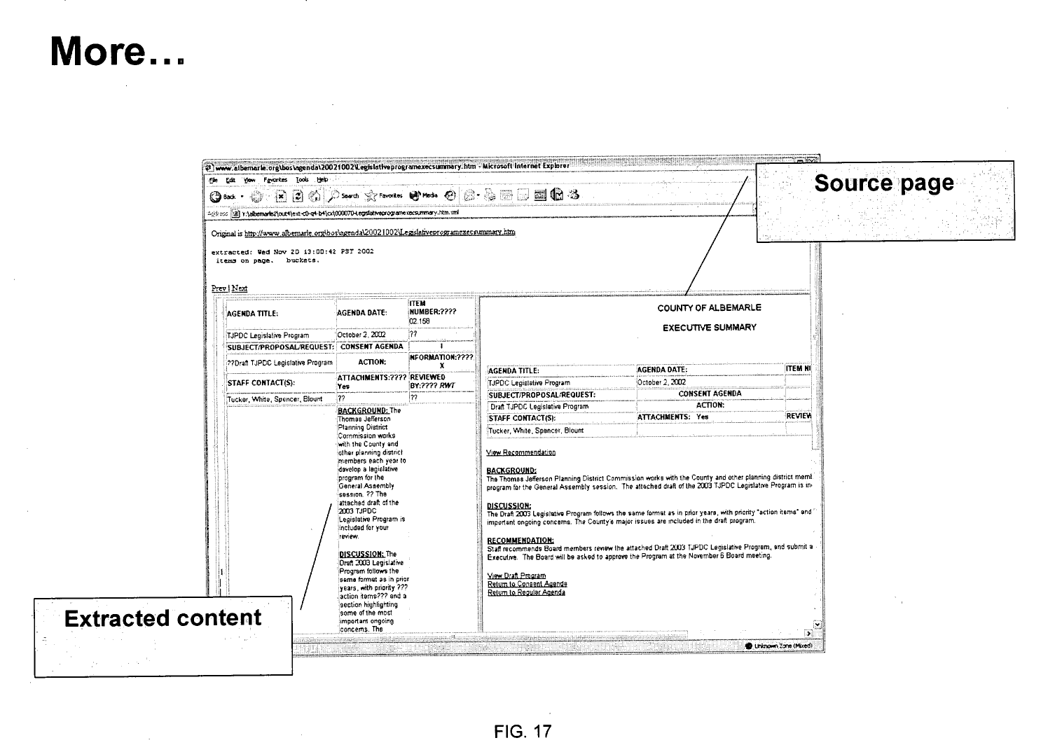

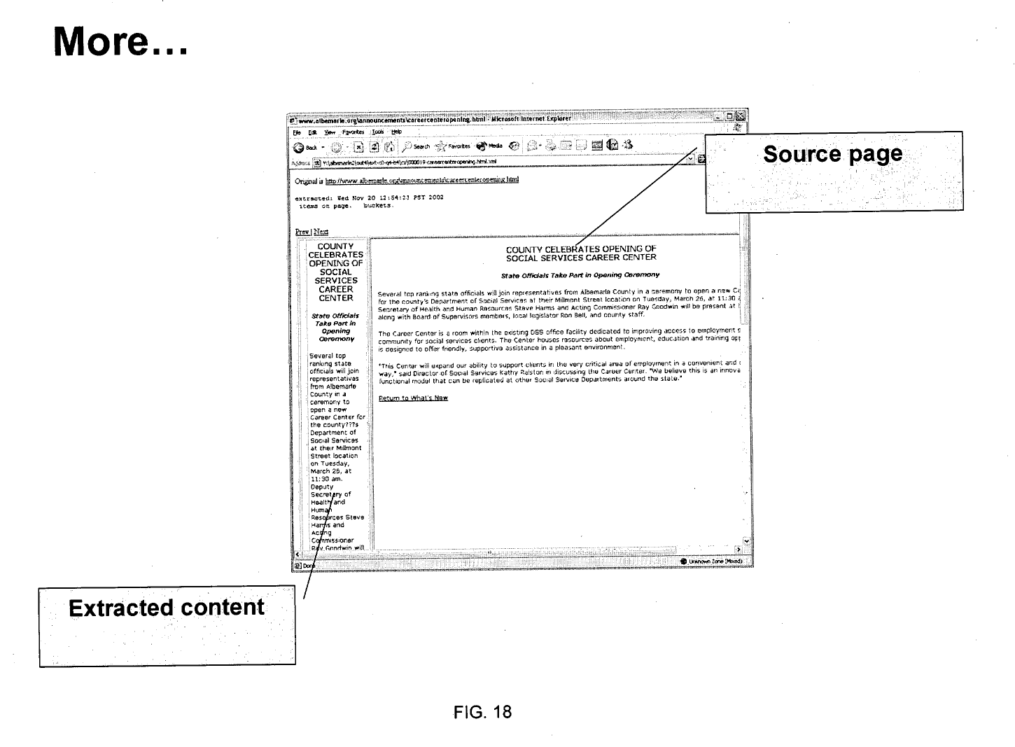

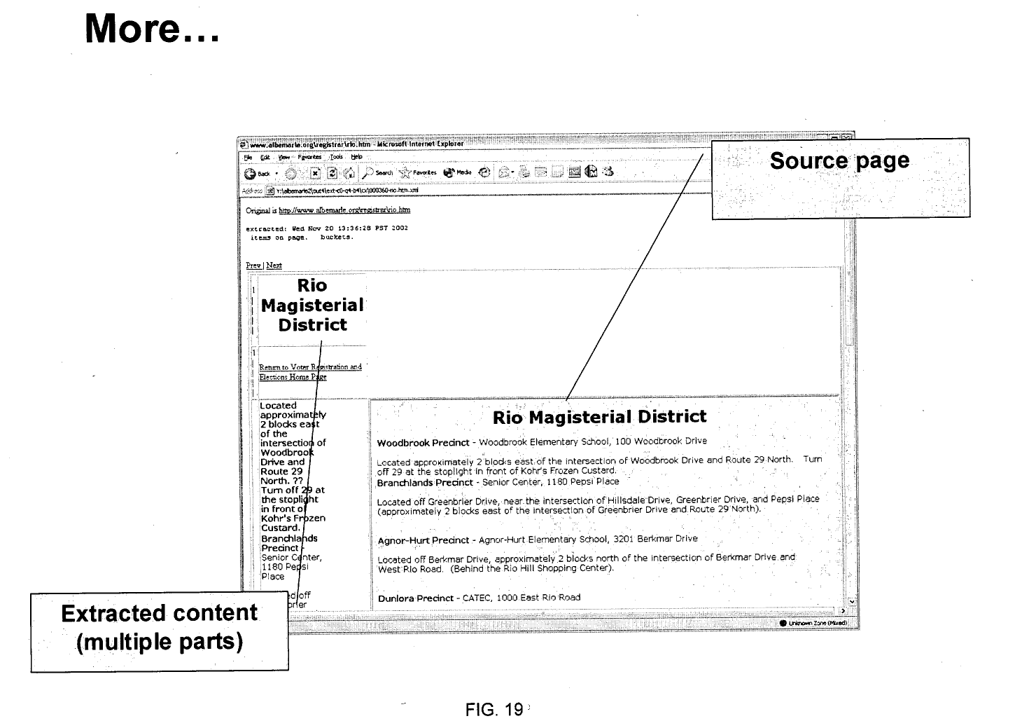

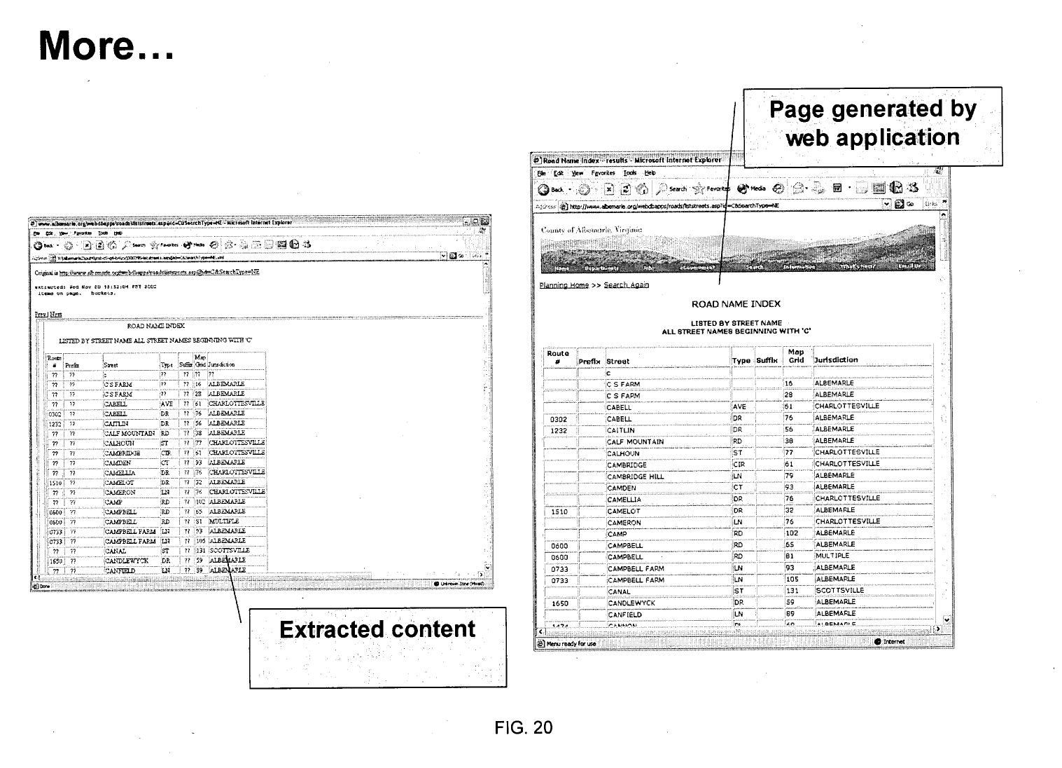

FIGS. 15, 16, 17, 18, 19, and 20 illustrate more examples of content, and extraction according to one embodiment of the invention. FIG. 15 shows the source (leftmost pane) and the extraction (rightmost pane). FIG. 16 shows another example of source (leftmost pane) and the extraction (rightmost pane) where Java applets are extracted. FIGS. 17 and 18 show other examples of source (rightmost pane) and the extracted content (leftmost pane). FIG. 19 shows a source page (rightmost pane) and content extracted into multiple parts (leftmost panes). FIG. 20 shows a page generated by a web application (rightmost pane) and the extracted content (leftmost pane).

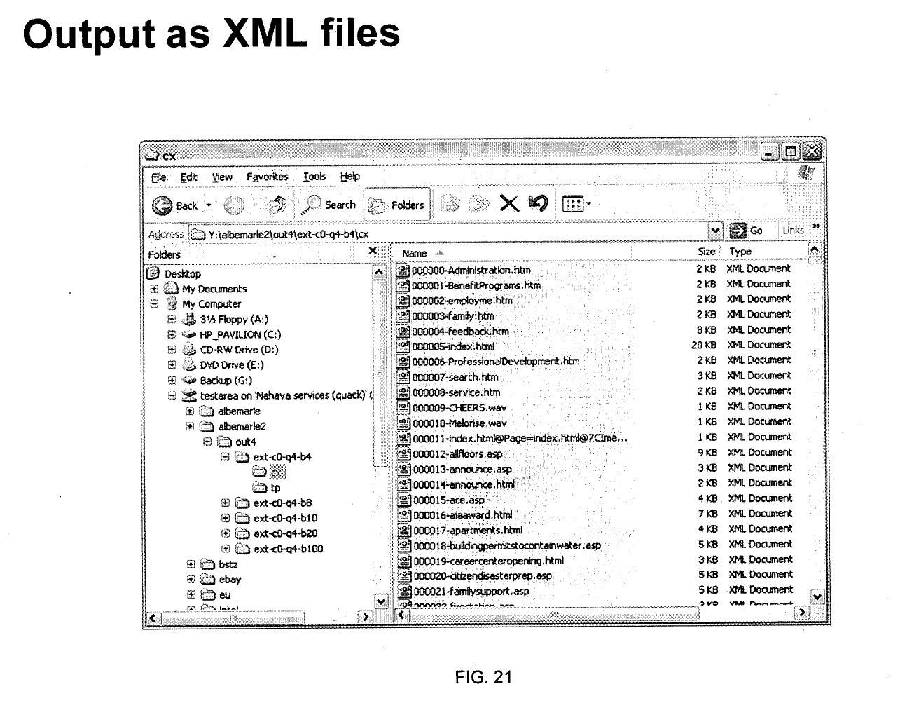

FIG. 21 illustrates output as a set of XML files according to one embodiment of the invention.

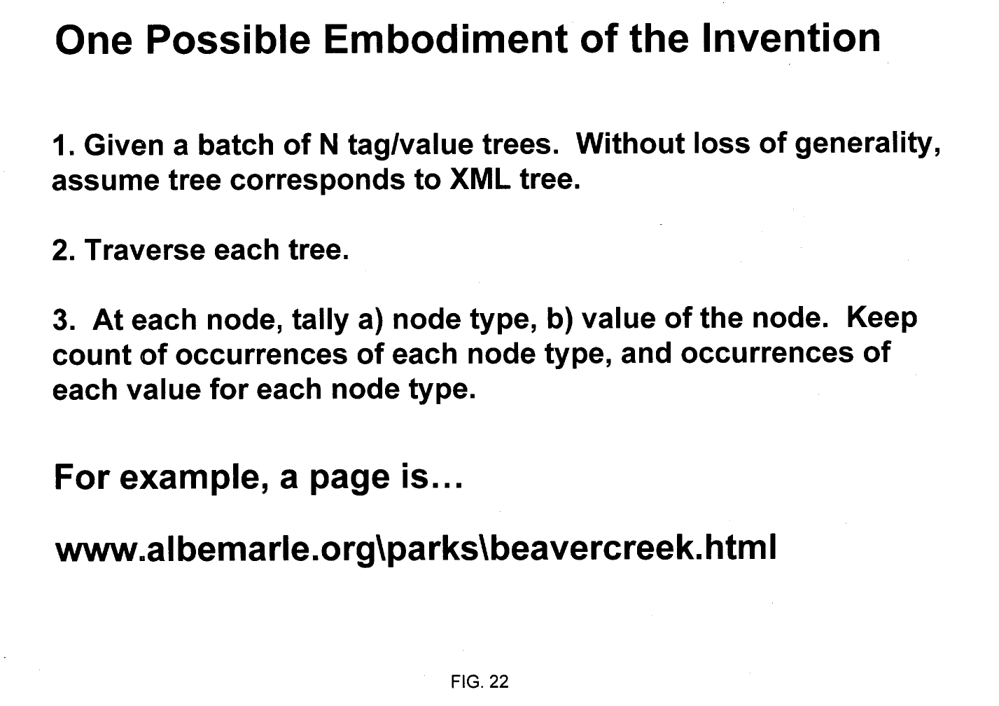

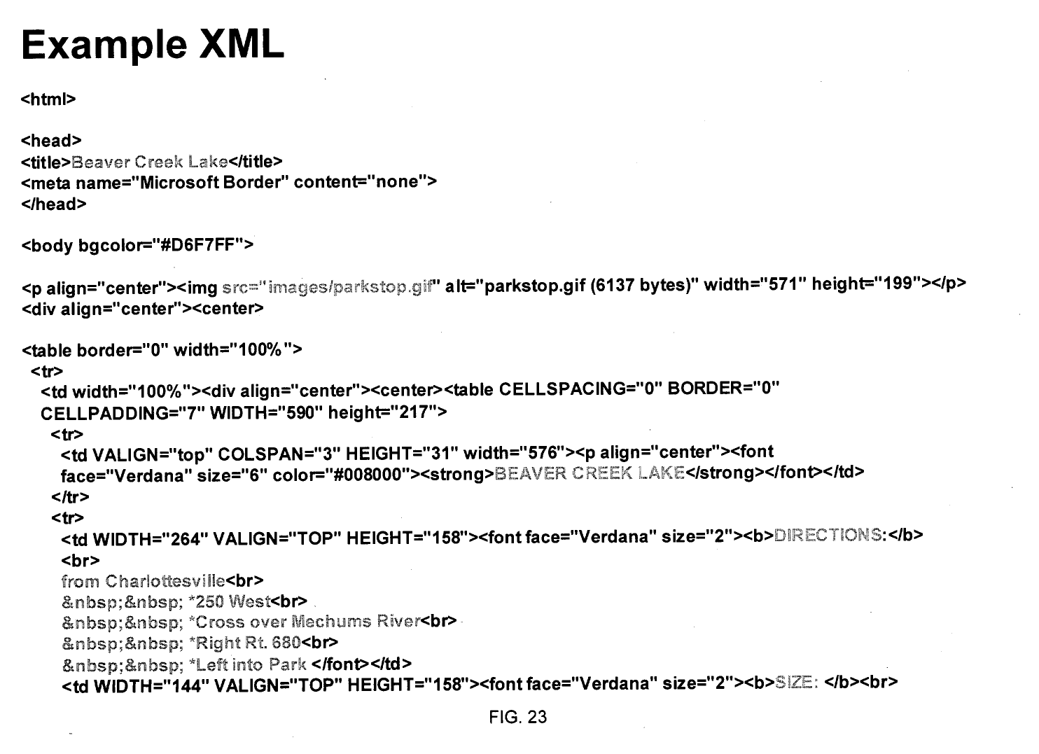

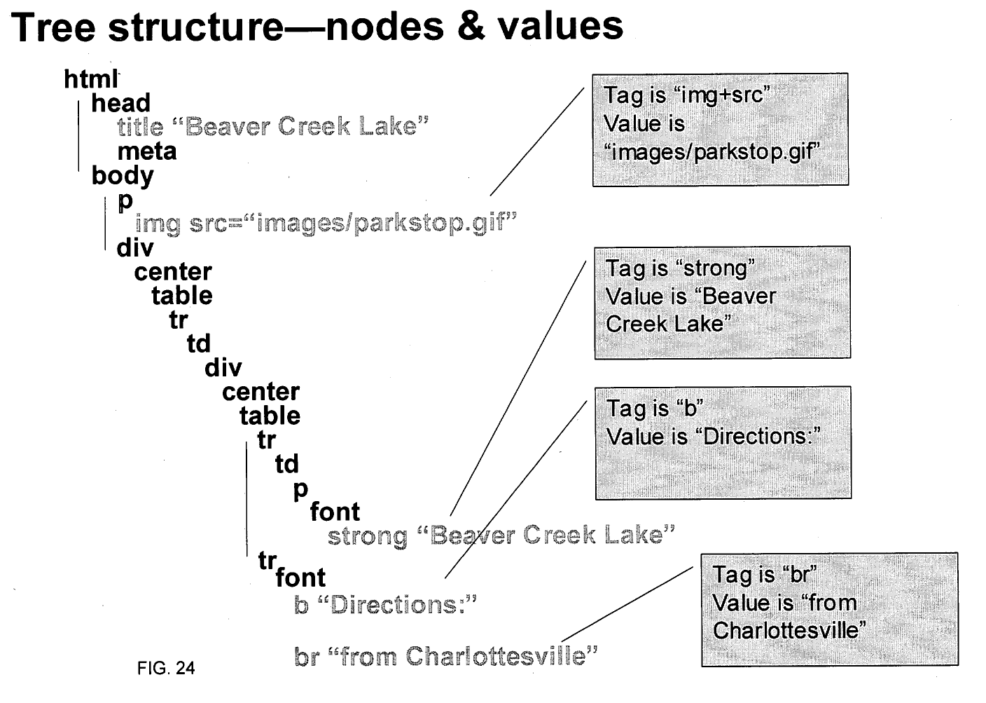

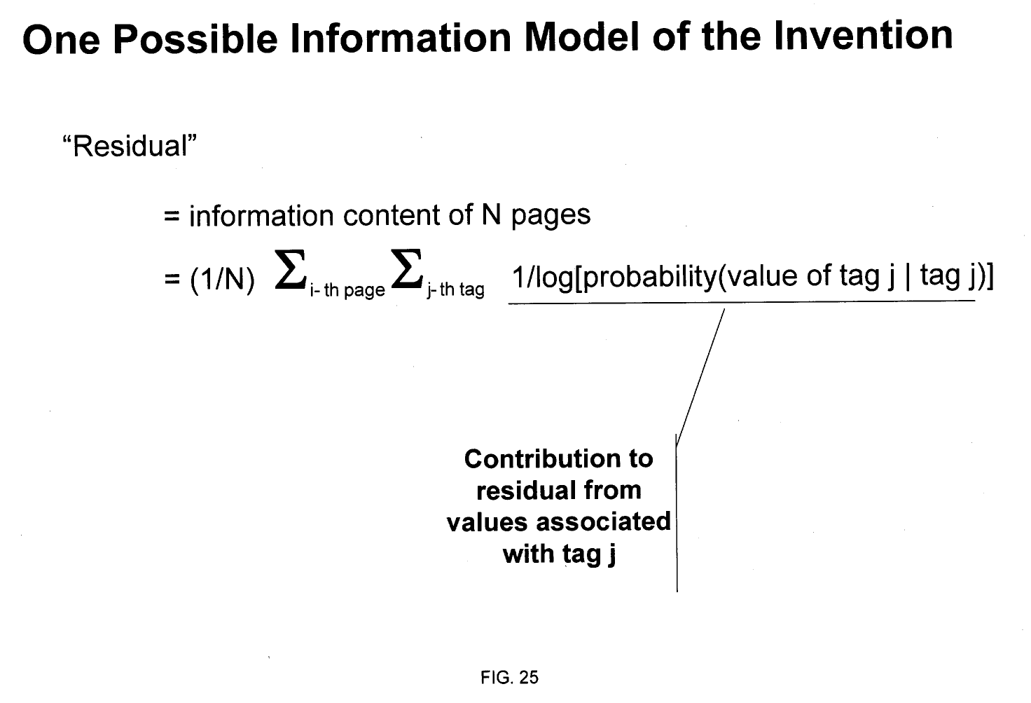

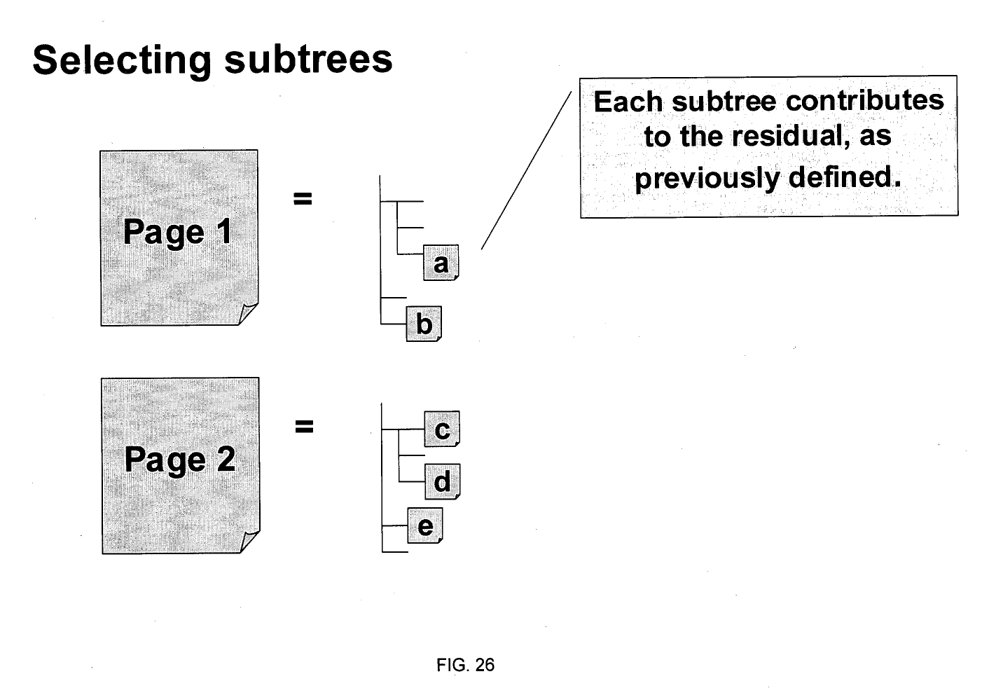

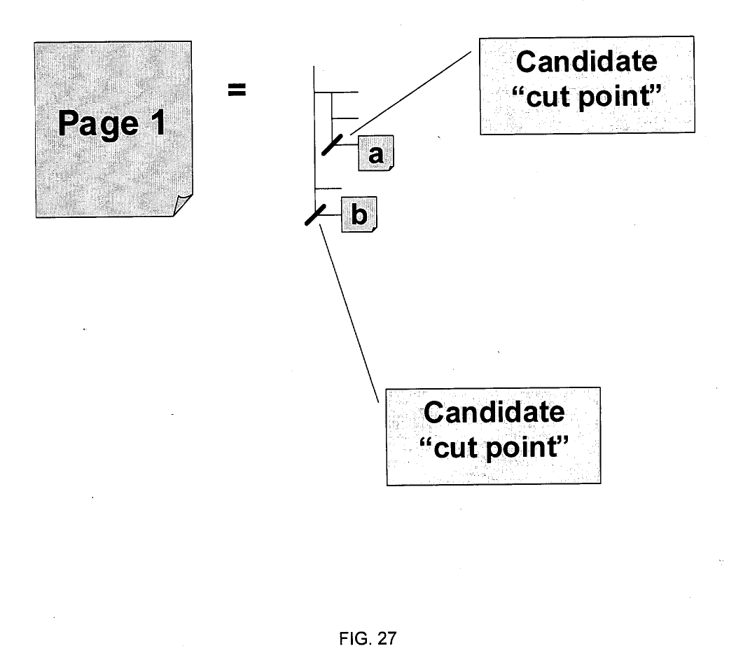

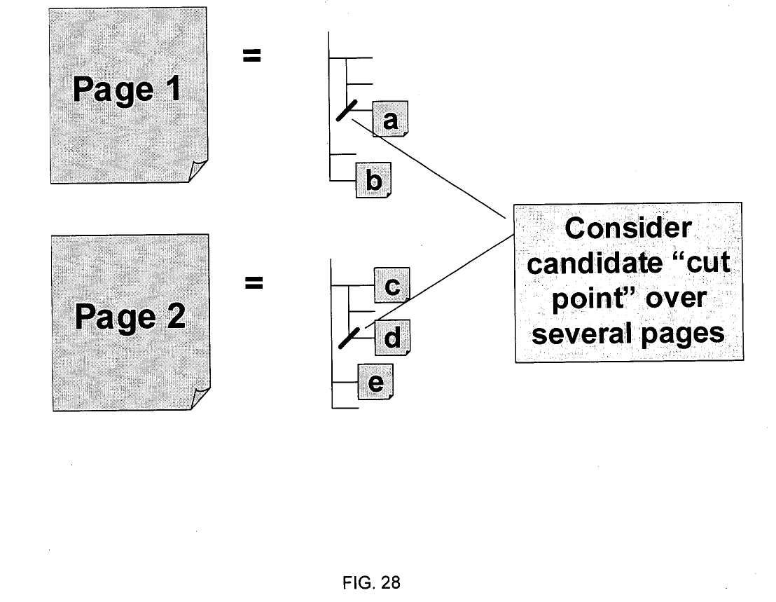

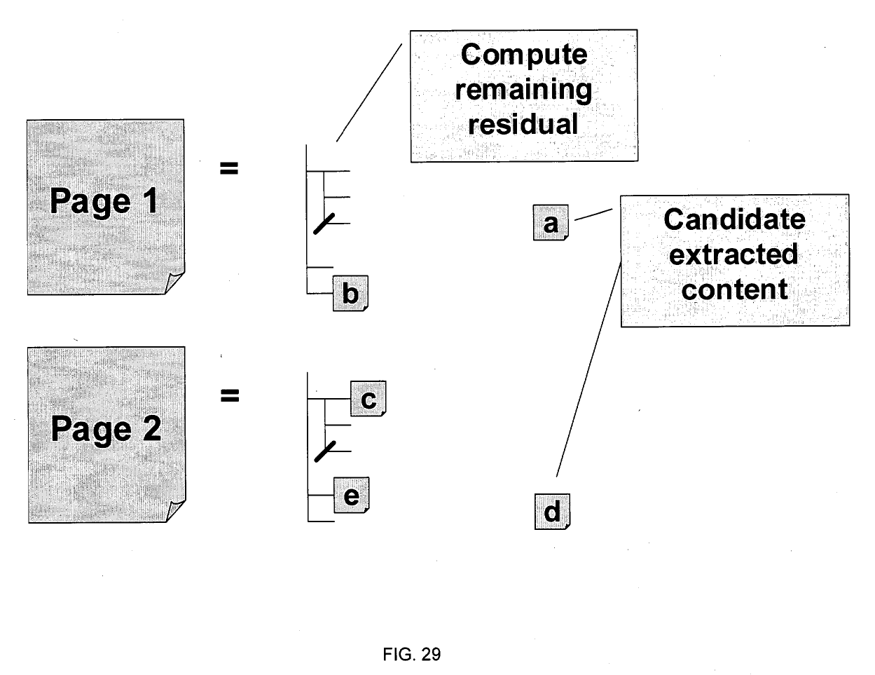

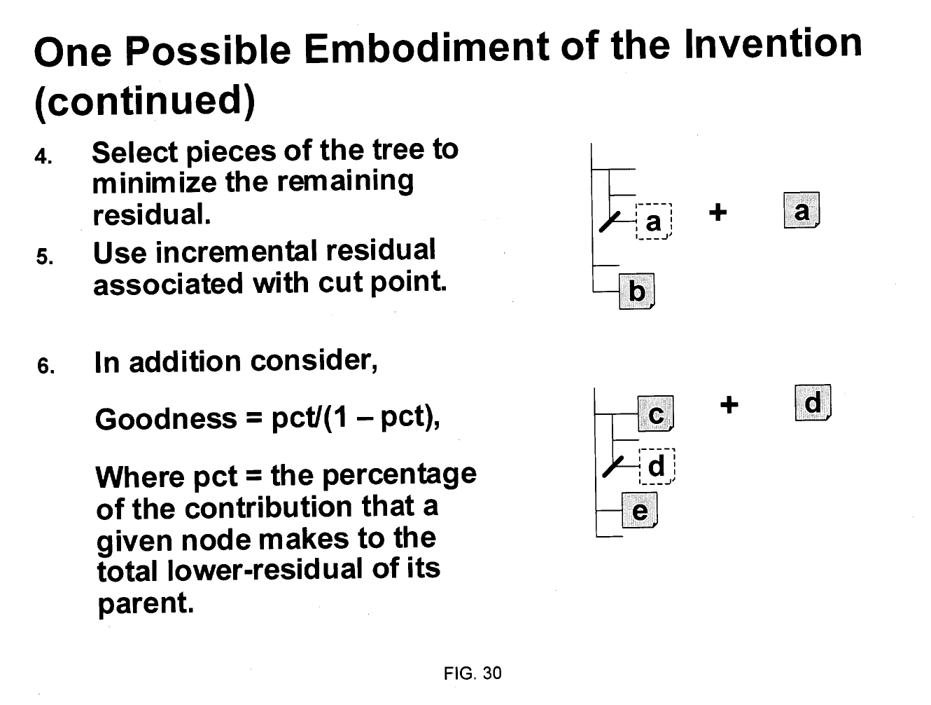

FIGS. 22, 23, 24, 25, 26, 27, 28, 29, and 30 illustrate one possible embodiment of the invention as a procedure, showing example XML, a tree structure, an information model, selecting subtrees, candidate cut points, residual, extracted content, and a goodness according to one embodiment of the invention. FIG. 22 illustrates the first three steps in this embodiment and will use as an example a Beaver Creek web site. Part of the example XML for the Beaver Creek web site is shown in FIG. 23. FIG. 24 shows the tree structure, nodes and values in this example. Various tags and values are indicated in the tree structure. FIG. 25 illustrates one information model for a residual. FIG. 26 illustrates two pages and their subtrees and hierarchical structure. FIG. 27 illustrates candidate cut points for page 1. FIG. 28 illustrates candidate cut points considered over several pages (here illustrated by pages 1 and 2). FIG. 29 illustrates cut points “a” and “d” where the candidate is the extracted content and the remaining residual is calculated. FIG. 30 illustrates three additional steps for determining a cut point.

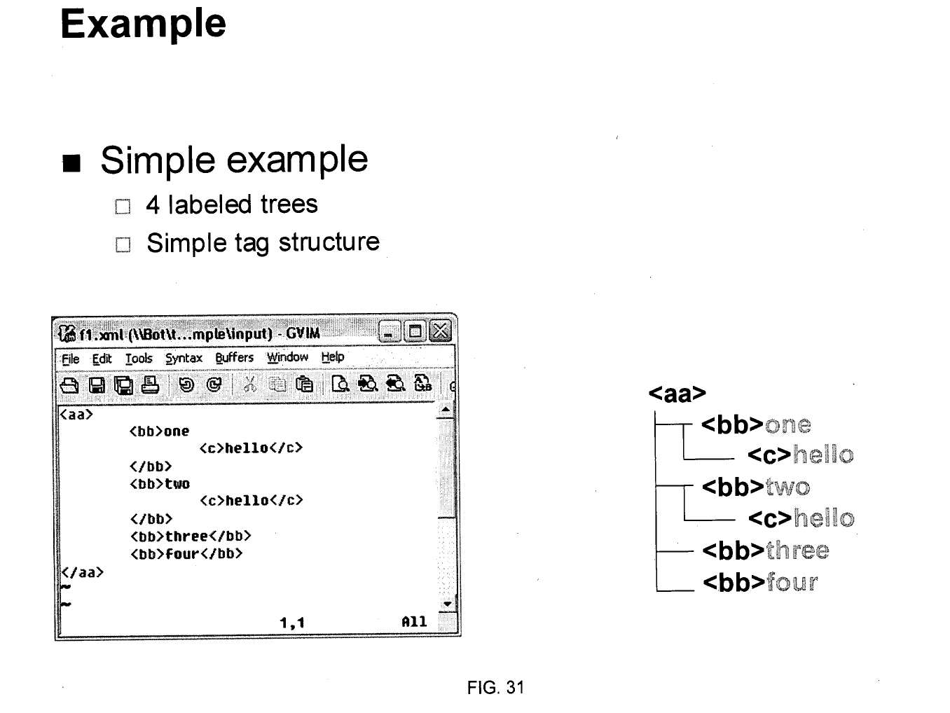

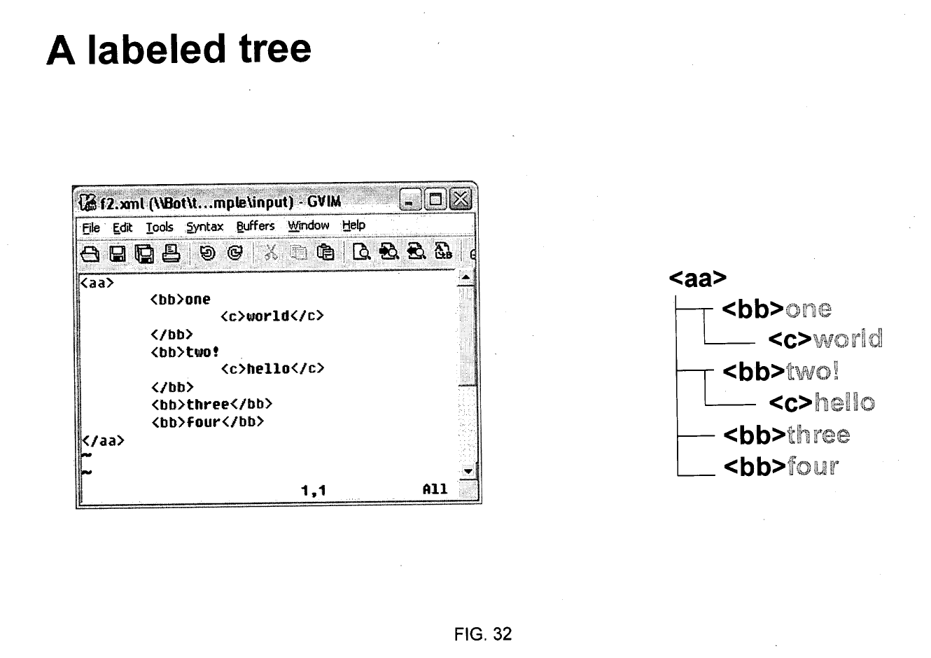

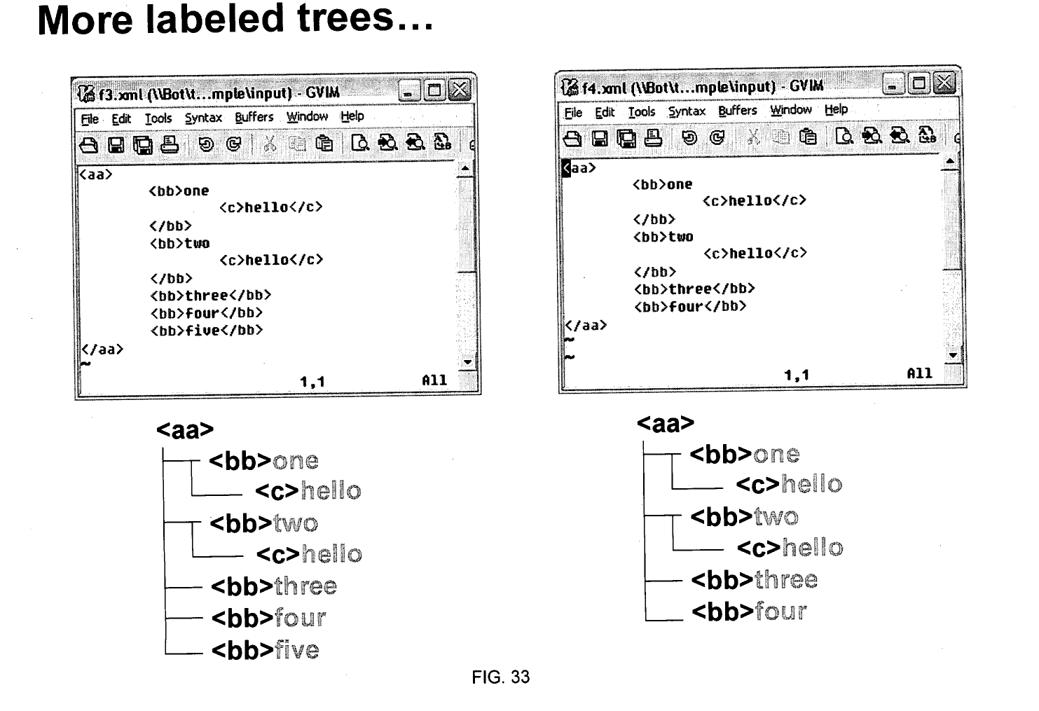

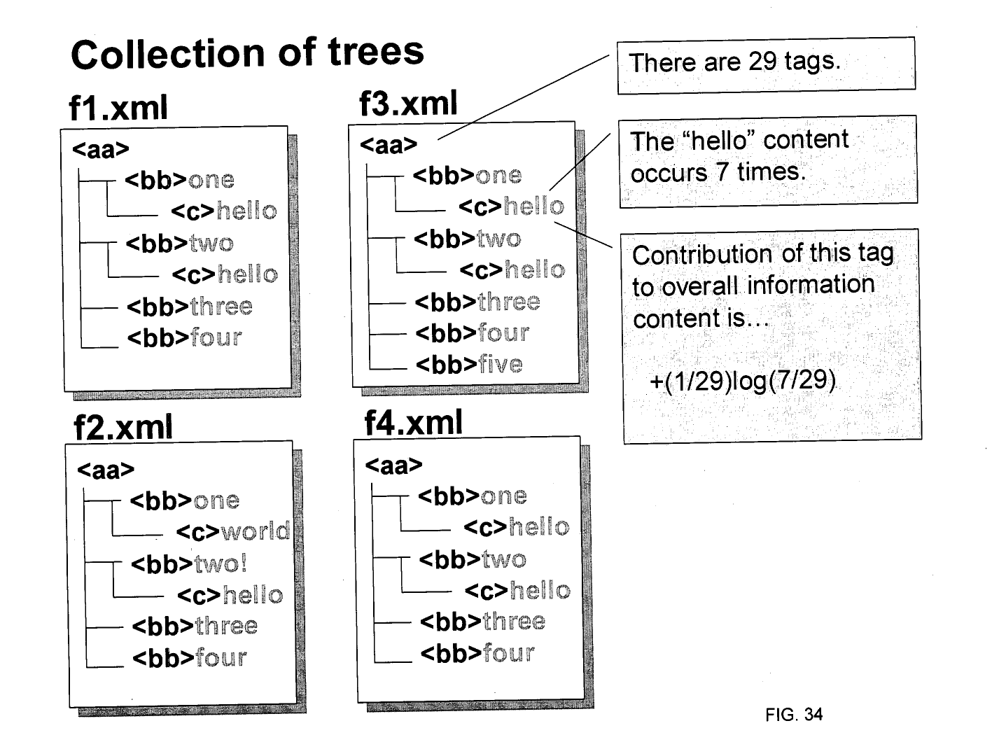

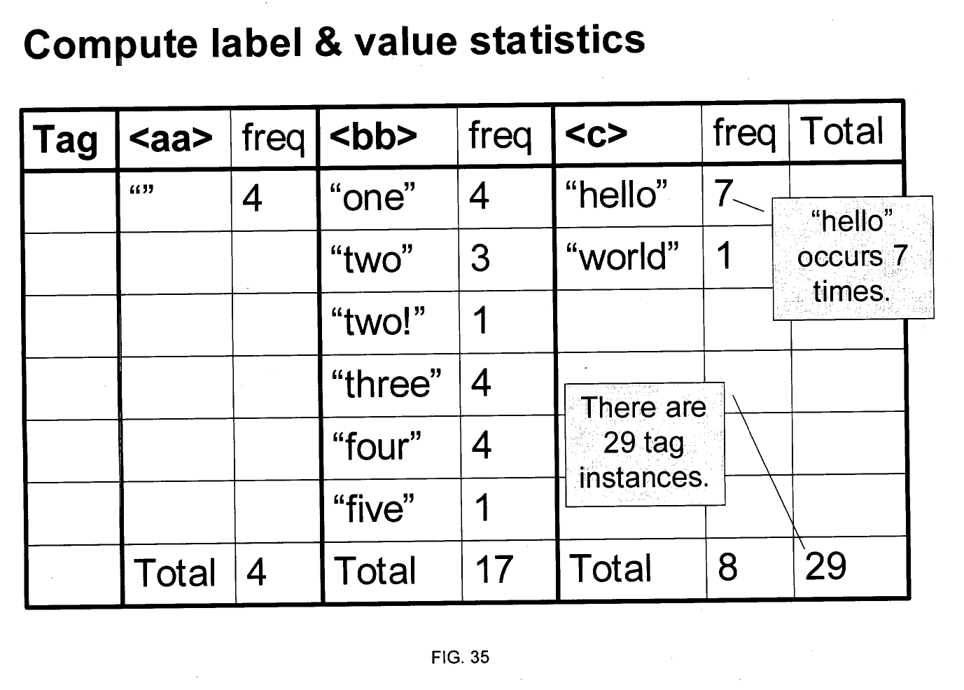

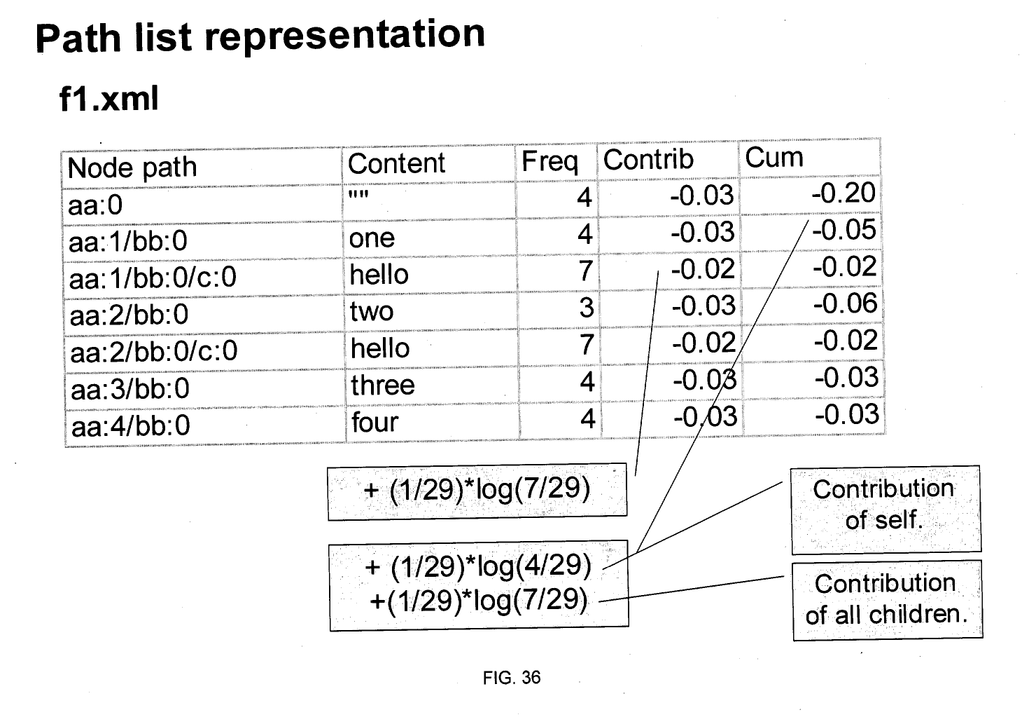

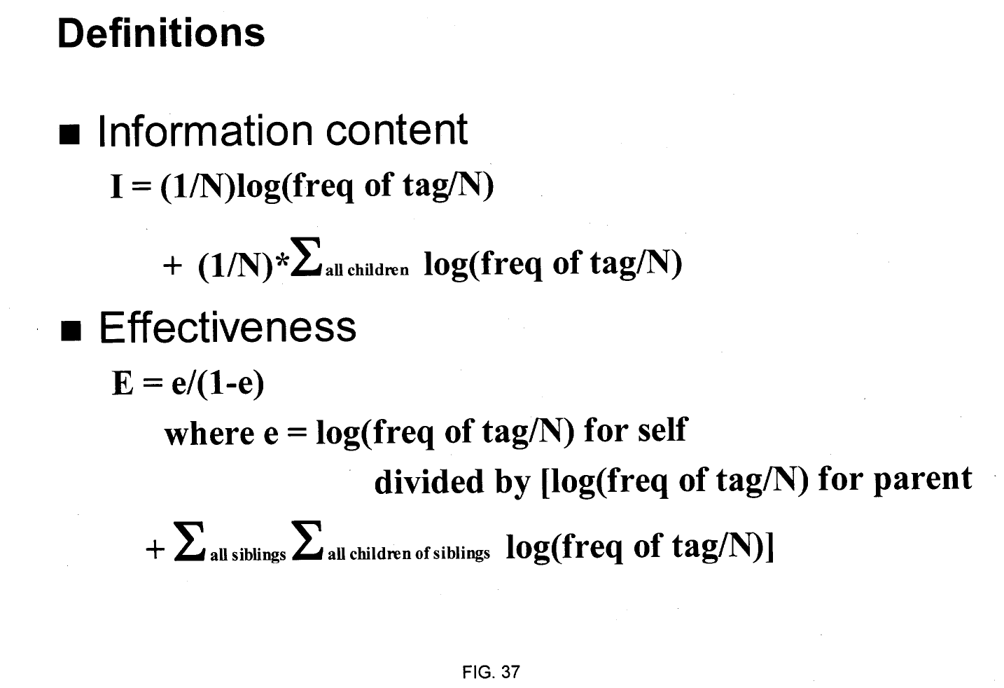

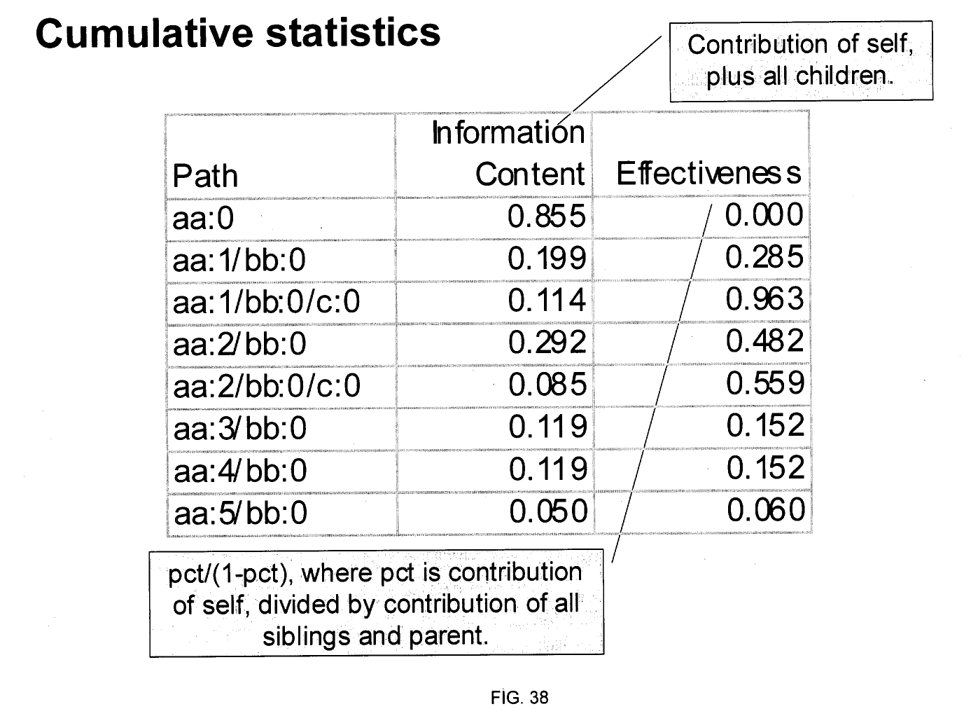

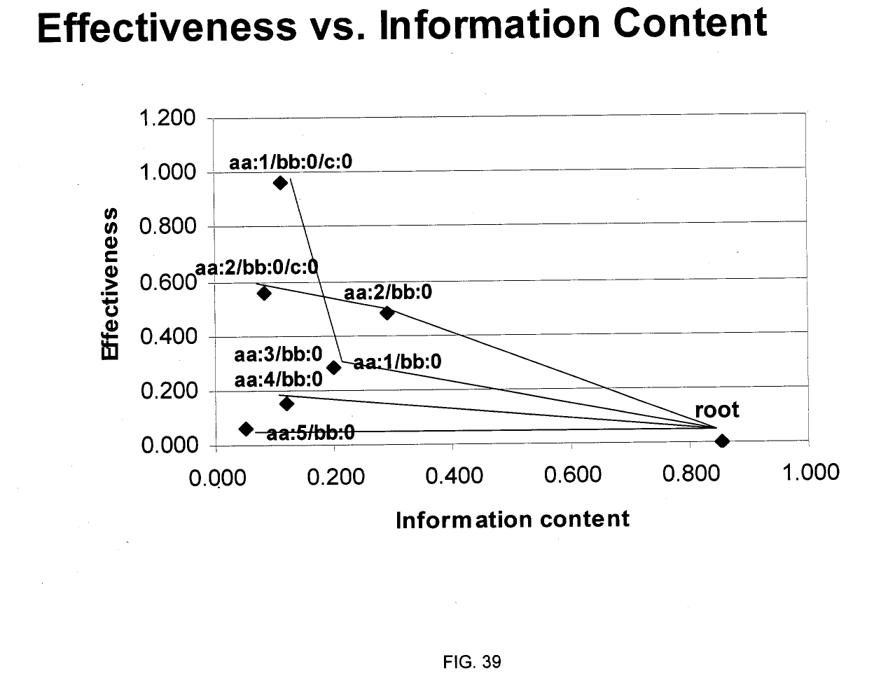

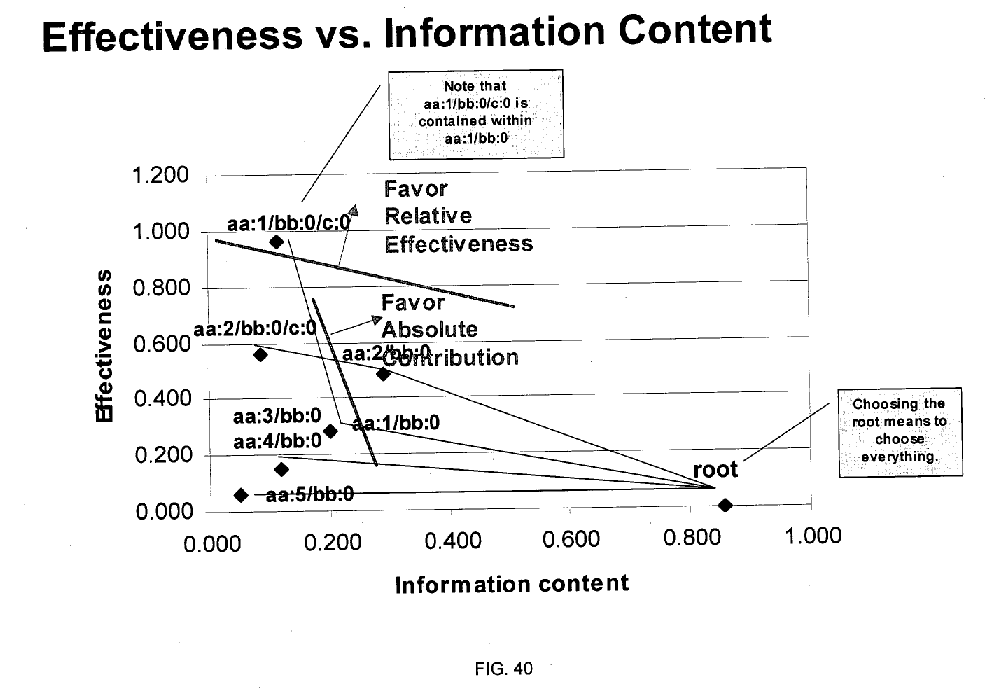

FIGS. 31, 32, 33, 34, 35, 36, 37, 38, 39, and 40 show the invention as illustrated in FIGS. 22-30 might operate on a simple example. FIG. 31 is an simple example with four labeled trees and a simple tag structure. The leftmost pane has the code for f1.xml (note label in title bar) and the rightmost has an equivalent tree structure. FIG. 32 illustrates the code and labeled tree for f2.xml. Note that f1.xml and f2.xml differ. FIG. 33 illustrates f3.xml and f4.xml. FIG. 34 illustrates the collection of trees for f1.xml, f2.xml, f3.xml, and f4.xml. Also noted are total tags of 29, and that “hello” content occurs 7 times. FIG. 35 is chart showing label and value statistics. FIG. 36 shows a path list representation for f1.xml showing the node path, content, frequency, contribution, and cumulative. Not shown are similar representations for f2.xml, f3.xml, and f4.xml. FIG. 37 shows one embodiment of definitions for information content and effectiveness. FIG. 38 shows cumulative statistics for a path, the information content, and the effectiveness. FIG. 39 is a labeled graph showing the effectiveness versus information content for this simple example. FIG. 40 illustrates two lines and an associated direction for favoring relative effectiveness and favoring absolute contribution. As noted on the graph some points are contained within others.

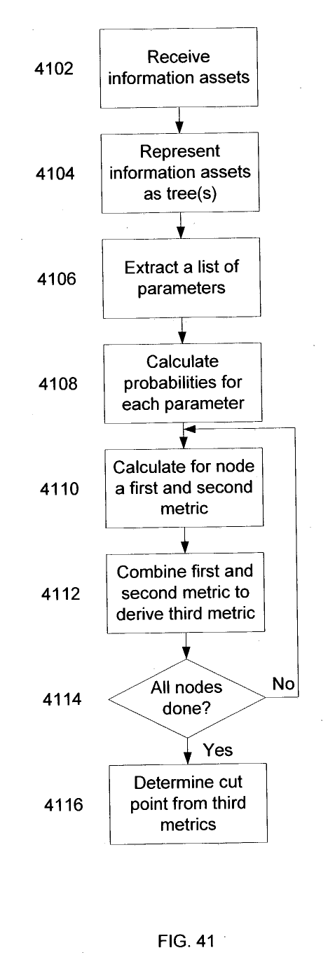

FIGS. 41, 42, 43, and 44 show in flowchart form various embodiments of the invention.

In FIG. 41, information assets are received 4102. These are then represented as possibly one or more trees 4104. For example, such a tree may be in the form of a directed acyclic graph (DAG). At 4106 a list of parameters is extracted from one or more trees and then the probabilities for each of these extracted parameters is calculated 4108. Next, at 4110, a first and a second metric are calculated for each node in the one or more trees. At 4112 a third metric is derived from the first and the second metric. A check is made at 4114 to determine if all nodes have been processed, and if not then the process goes to 4110 again. If all nodes have been processed then a determination of a cut point is made by using the third metrics 4116.

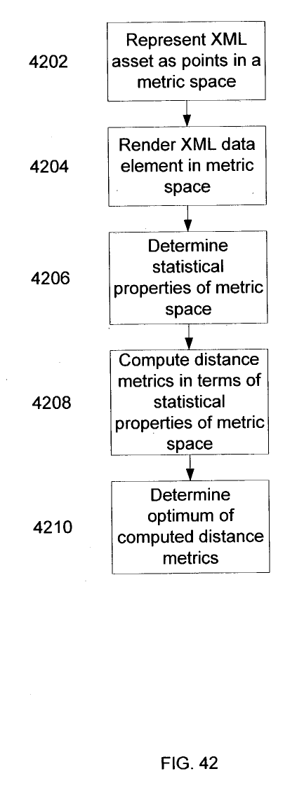

In FIG. 42, XML assets are represented as points in a metric space 4202. Next XML data elements are rendered in a metric space 4204. At 4206 statistical properties of the metric space are determined. Next, distance metrics are computed in terms of the statistical properties of the metric space 4208. An optimum of the computed distance metrics is then determined 4210.

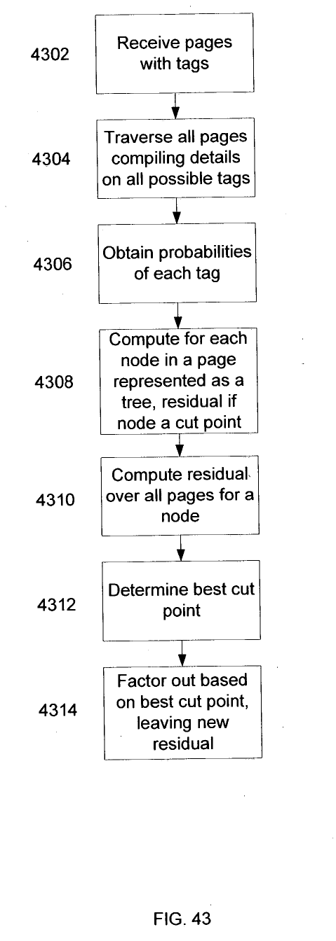

In FIG. 43, pages with tags, such as web pages, are received at 4302. Next, all pages are traversed and a compilation is made of all possible tags. At 4306, the probabilities of each tag is determined. For each node in a page represented as a tree a residual is computed as if the node was the cut point 4308. Next at 4310, the residual is computed over all pages for a node. A best cut point is determined 4312. Next, factoring out is based on the best cut point leaving a new residual 4314.

One skilled in the art will appreciate that the residual obtained at 4314 may serve as the input for another iteration through sequence 4302 to 4314.

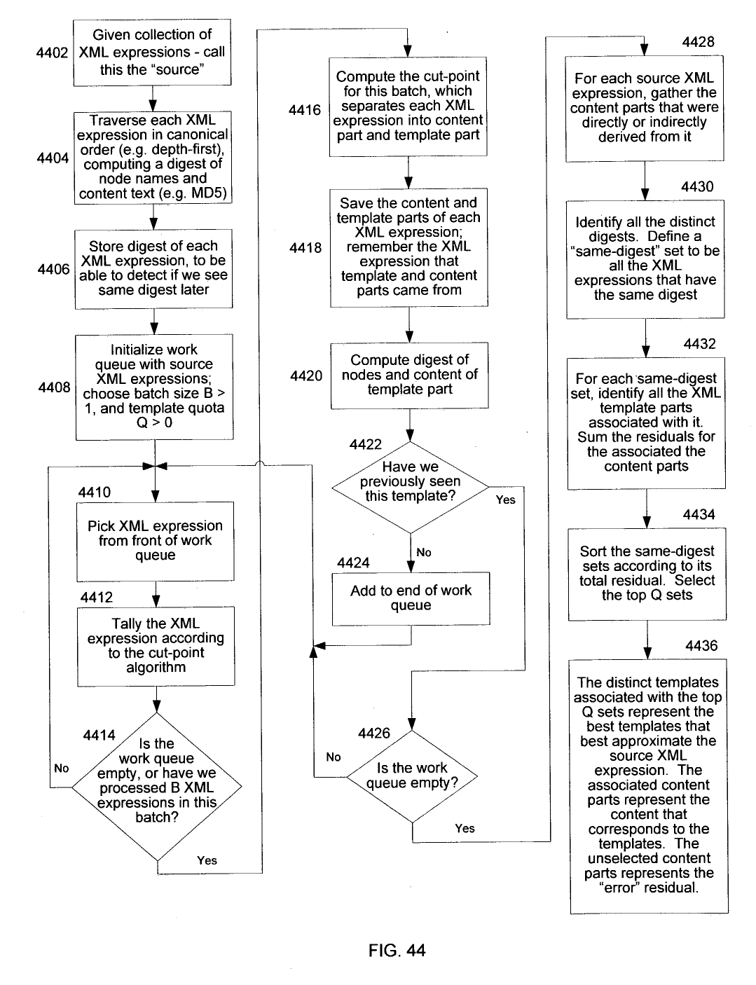

In FIG. 44 at 4402 a given collection of XML expressions is called the “source.” Next at 4404 Traverse each XML expression is traversed in canonical order (e.g. depth-first), computing a digest of node names and content text (e.g. MD5). At 4408 the digest of each XML expression is stored, so that it is possible to detect if this same digest is seen later. At 4408 initialization is done to initialize the work queue with source XML expressions; choosing a batch size B>1, and template a quota Q>0. Next at 4410 an XML expression is picked from the front of work queue. At 4412 a tally of the XML expression according to the cut-point algorithm is made. At 4414 a check is made to see if the work queue is empty, or if B XML expressions have been processed in this batch? If the work queue is not empty and B XML expressions have not been processed then the sequence proceeds to 4410. If the work queue is empty or B XML expressions have been processed then proceed to 4416. At 4416 the cut-point for this batch are computed, which separates each XML expression into a content part and a template part. Next at 4418 the content and template parts of each XML expression are saved, as well as information to remember the XML expression that the template and the content parts came from. Next at 4420 compute the digest of nodes and content of template part. At 4422 a check is made to determine if this template was previously seen? If the template has not been previously seen then at 4424 the template is added to the end of the work queue and proceed to 4410. If the template has been previously seen then proceed to 4426 where a check is made to determine if the work queue is empty. If the work queue is not empty the proceed to 4410. If the work queue is empty the proceed to 4428. At 4428 for each source XML expression, the content parts that were directly or indirectly derived from it are gathered. Next at 4430 all the distinct digests are identified. Where by definition a “same-digest” set is to be all the XML expressions that have the same digest. At 4432 for each same-digest set, identify all the XML template parts associated with it. Sum the residuals for the associated the content parts. Next at 4434 sort the same-digest sets according to its total residual. Select the top Q sets. Then at 4436 the distinct templates associated with the top Q sets represent the best templates that best approximate the source XML expression. The associated content parts represent the content that corresponds to the templates. The unselected content parts represents the “error” residual.

Thus, a method, and apparatus for information factoring have been described.

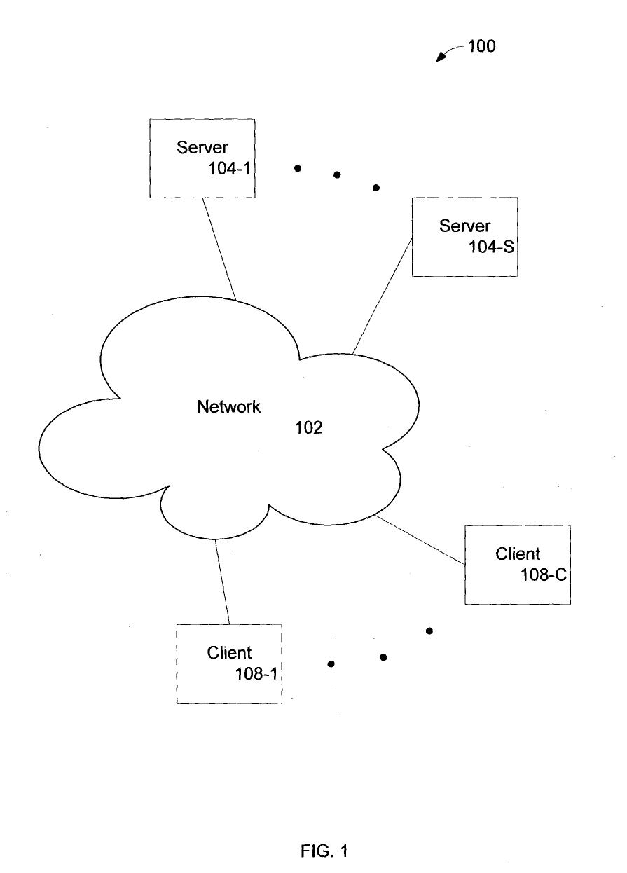

FIG. 1 illustrates a network environment 100 in which the techniques described may be applied. The network environment 100 has a network 102 that connects S servers 104-1 through 104-S, and C clients 108-1 through 108-C. More details are described below.

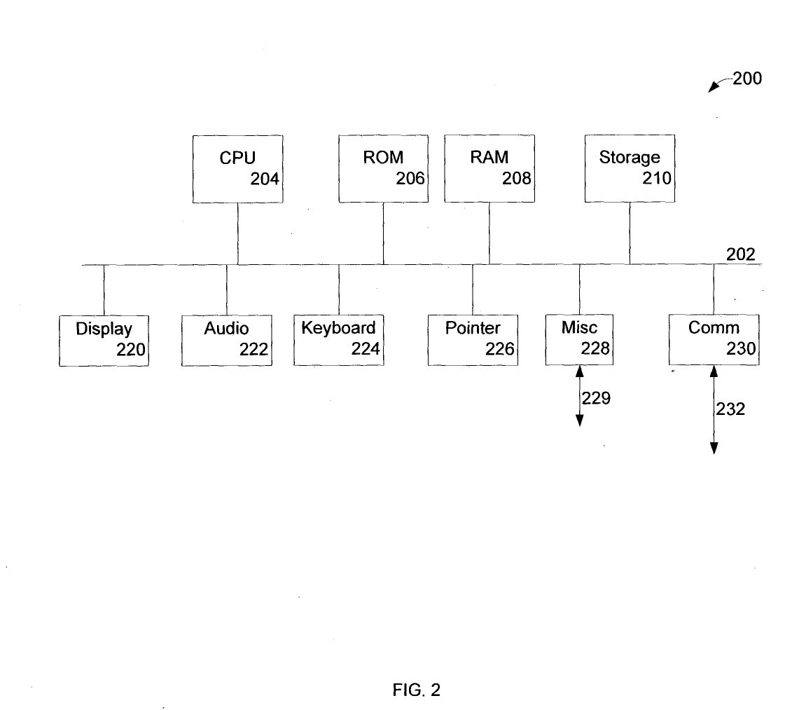

FIG. 2 illustrates a computer system 200 in block diagram form, which may be representative of any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus, a method and apparatus for information factoring have been described.

What is claimed is:

1. A method comprising:
representing a source information asset as a point in a metric space; and
rendering said source information asset in a second form.

2. The method of claim 1 wherein said second form is substantially redundant information contained in said source information asset.

3. The method of claim 1 wherein said second form is substantially non-redundant information contained in said source information asset.

4. The method of claim 1 wherein said rendering is language neutral.

5. The method of claim 1 wherein said second form conforms substantially to the extensible markup language (XML).

6. The method of claim 1 further comprising generating a directed acyclic graph (DAG) of said source information asset.

7. The method of claim 1 wherein said source information asset comprises one or more web pages.

8. A machine-readable medium having stored thereon instructions, which when executed performs the method of claim 1.

9. A system comprising a processor coupled to a memory, which when executing a set of instructions performs the method of claim 1.

10. The method of claim 1 further comprising communicating a payment and/or credit.

11. A method for information factoring comprising:
receiving one or more information assets;
representing said one or more information assets in a tree topology;
extracting from said one or more information assets a list of one or more different parameters;
calculating probabilities associated with each said one or more different parameters for each said one or more information assets;
(a) calculating for selected nodes in said tree topology a first metric and a second metric;
(b) combining said first metric and said second metric to derive a third metric;
repeating (a) and (b) thus generating a plurality of said third metrics; and
determining a specific optimum cut-point based upon said plurality of third metrics.

12. The method of claim 11 wherein said determining said specific optimum cut-point further comprises preference relating to an effectiveness parameter.

13. The method of claim 11 wherein said determining said specific optimum cut-point further comprises preference relating to an information content parameter.

14. The method of claim 11 wherein said selected nodes is each node.

15. The method of claim 11 wherein said set of nodes is every node.

16. The method of claim 11 wherein calculating probabilities further comprises traversing over each said one or more information assets as represented in said tree topology.

17. The method of claim 11 wherein said (a) calculating for selected nodes in said tree topology a first metric and a second metric comprises (a) calculating for selected nodes in said tree topology a first metric based upon nodes above a cut-point and a second metric based upon nodes below said cut-point.

18. The method of claim 17 wherein said (b) combining said first metric and said second metric to derive a third metric comprises (b) combining said first metric and said second metric to derive a third metric for said cut-point in said tree topology;

19. The method claim 18 wherein said repeating (a) and (b) thus generating a plurality of said third metrics comprises moving said cut-point between a set of nodes in said tree topology and repeating (a) and (b) thus generating a plurality of said third metrics.

20. The method of claim 19 wherein said set of nodes is every node.

21. The method claim 18 wherein said repeating (a) and (b) thus generating a plurality of said third metrics comprises moving said cut-point between every possible set of nodes in said tree topology by traversing said tree topology from root downward and repeating (a) and (b) thus generating a plurality of said third metrics.

22. A method for information factoring comprising:
(a) receiving N information assets capable of being represented in a tree topology;
(b) extracting from said N information assets a list of one or more different parameters;
(c) traversing over each said N information assets and calculating probabilities associated with each said one or more different parameters for each said N information assets;
(d) calculating for each node in said tree topology a first metric based upon nodes above a cut-point and a second metric based upon nodes below said cut-point;
(e) combining for each node in said tree topology said first metric and said second metric to derive a third metric for said cut-point in said tree topology;
(f) moving said cut-point between every possible set of nodes in said tree topology by traversing said tree topology from root downward and repeating (d) and (e) thus generating a plurality of said third metrics;
(g) determining a specific optimum cut-point by calculating which of the plurality of cut-points has a highest rate of change in said plurality of third metrics.

23. A system comprising a processor coupled to a memory, which when executing a set of instructions performs the method of claim 1.

24. The method of claim 1 wherein after (g) determining said specific optimum cut-point, said information is factored out of N leaving N′ information assets and applying (a)-(g) of claim 1 to said N′ as if they were N.

25. A method comprising:
representing one or more XML web assets as one or more points in a metric space;
rendering one or more XML data elements in said metric space;
determining statistical properties of said metric space;
computing one or more distance metrics in terms of said statistical properties of said metric space; and
determining an optimum of said one or more computed distance metrics.

26. The method of claim 25 wherein rendering one or more XML data elements further comprises using a presentation template as multiplication in said metric space.

27. The method of claim 26 wherein said presentation template is a XSL.

28. The method of claim 26 wherein determining an optimum of said one or more computed distance metrics further comprises:
obtaining a factoring between template and content to solve min(xp, sum(xi contained in S, ∥xi−xp*xci∥))
where:
xp denotes said presentation template,
S denotes a set of points in said metric space,
xi denotes said XML data elements, and
xci denotes extracted content.

29. An apparatus comprising:
means for representing a source information asset as a point in a metric space; and
means for rendering said source information asset in a second form.

30. A machine-readable medium having stored thereon information representing the apparatus of claim 29.

31. A method for factoring information, the method comprising:
receiving information to be factored;
converting said information into one or more directed acyclic graphs (DAGs);
extracting for each node in said one or more DAGs an effectiveness and information content metric; and
choosing one or more factor points based upon said effectiveness and information content metrics.

32. A machine-readable medium having stored thereon instructions, which when executed performs the method of claim 31.

33. A system comprising a processor coupled to a memory, which when executing a set of instructions performs the method of claim 31.

34. A method of information factoring comprising:
(a) receiving pages (yi), said pages having tags (tj) within each page;
(b) traversing all said pages yi, and compiling details on all possible tags (tij);
(c) traversing over said all possible tags tij for each page yi and obtaining probabilities of the tag values;
(d) computing for each node in a tree for page yi, the residual as if that node and nodes above were to be considered part of a template, and everything below that node would be part of an extraction, and would not contribute to a residual.
(e) taking the potential residuals computed in (d) over all the pages, and computing the residual associated with a node and everything below it;
(f) determining a best cut point by looking at the rate of change of the total residual below each candidate cut point considering the total sum of residuals for all nodes that have the cut point as a direct or indirect parent node and picking an optimal cut point as a point (or points) that define a “knee” in the residual curve, plotted as a function of sorted potential cut points.

35. The method of claim 34 further comprising:
(g) removing that residual from the total for all the pages if that node were chosen as the template denoting this a new residual; and
repeating (b)-(f) with said new residual.

36. The method of claim 34 wherein determining the best cut point further comprises calculating the following ratio:
Goodness=pct/(1−pct),
where pct=the percentage of the contribution that a given node makes to the total lower-residual of its parent.

37. The method of claim 35 wherein reconstructing the original received pages comprises summing all the residuals.

38. A method comprising:
computing a digest of node names and content text for one or more XML expressions;
tallying said XML expressions according to a cut-point algorithm;
separating each XML expression into a content part and a template part using said cut-point algorithm;
gathering for each said one or more XML expressions said content parts directly or indirectly derived from each said one or more XML expressions;
identifying all distinct digests into one or more same-digest sets;
for each same-digest set;
identifying all XML template parts associated with said same-digest set; and
summing residuals for said same-digest set content parts;
sorting said same-digest sets based on said same-digest sets' residual; and
selecting N top said sorted same-digest sets.

39. The method of claim 38 wherein said computing a digest of node names and content text for one or more XML expressions further comprises traversing each said one or more XML expressions in canonical order.

40. The method of claim 38 wherein said same-digest sets is defined as one or more XML expressions having a same digest

41. A machine-readable medium having stored thereon instructions, which when executed performs the method of claim 38.

42. A system comprising a processor coupled to a memory, which when executing a set of instructions performs the method of claim 38.
